(19) United States
(12) Patent Application Publication
(10) Pub. No.: US 2021/0304474 A1
(43) Pub. Date: Sep. 30, 2021

(54) INFORMATION PROCESSING APPARATUS, INFORMATION PROCESSING METHOD, AND PROGRAM

(71) Applicant: Sony Corporation, Tokyo (JP)

(72) Inventors: Hiroyuki Kobayashi, Kanagawa (JP); Akihiro Hokimoto, Kanagawa (JP)

(21) Appl. No.: 17/258,980

(22) PCT Filed: Jul. 24, 2019
(86) PCT No.: PCT/JP2019/029087

§ 371 Date: Jan. 8, 2021

(30) Foreign Application Priority Data
Aug. 3, 2018 (JP) 2018-147247

(51) Int. Cl. G06T 11/60

(52) U.S. Cl. CPC G06T 11/60

(57) ABSTRACT

An information processing apparatus, an information processing method, a non-transitory computer-readable medium, and an information processing apparatus. The information processing apparatus includes an area information generating circuitry, a detection circuitry, and an area selection circuitry. The area information generating circuitry is configured to generate area information indicating each area of each image of a plurality of images, the plurality of images being projected onto a projection surface. The detection circuitry is configured to detect one or more areas that are designated by a user operation out of a plurality of areas, the plurality of areas based on the area information that is generated. The area selecting circuitry is configured to select a portion of the plurality of areas based on the one or more areas that are detected.

### CROSS REFERENCE TO RELATED APPLICATIONS

This application claims the benefit of Japanese Priority Patent Application JP 2018-147247 filed on Aug. 3, 2018, the entire contents of which are incorporated herein by reference.

### TECHNICAL FIELD

The present technology relates to an information processing apparatus, an information processing method, and a program and particularly to a technical field which can be used for mapping a plurality of images.

### BACKGROUND ART

For example, a technique of capturing an image using an imaging device which is mounted in a flying object flying above the surface of the earth such as a drone and combining a plurality of captured images using a mapping process is known.

### Citation List

### Patent Literature

[PTL 1]

JP 2000-292166A

### SUMMARY

### Technical Problem

The plurality of captured images may include an image which is not suitable for combination, arid such an image which is not suitable for combination should be preferably excluded in order to reduce a processing load of a mapping process, for example, based on stitch or the like. However, determination of whether an image is suitable for combination often depends on a user's experience.

Therefore, it is desirable to provide an information processing apparatus, an information processing method, and a program that enable performing a mapping process on the basis of a user's determination.

### Solution to Problem

According to the present technology, there is provided an information processing apparatus including an area information generating circuitry, a detection circuitry, and an area selecting circuitry. The area information generating circuitry is configured to generate area information indicating each area of each image of a plurality of images, the plurality of images being projected onto a projection surface. The detection circuitry is configured to detect one or more areas that are designated by a user operation out of a plurality of areas, the plurality of areas based on the area information that is generated. The area selecting circuitry is configured to select a portion of the plurality of areas based on the one or more areas that are detected.

According to the present technology, there is provided an information processing method. The method includes generating, with an area information generating circuitry, area information indicating each area of each .image of a plurality of images, the plurality of images being projected onto a projection surface. The method includes detecting, with a detection circuitry, one or more areas that are designated by a user operation out of a plurality of areas, the plurality of areas based on the area information that is generated. The method also includes selecting, with an area selecting circuitry, a portion of the plurality of areas based on the one or more areas that are detected.

According to the present technology, there is provided a non-transitory computer-readable medium comprising instructions that, when executed by an electronic processor, cause the electronic processor to perform a set of operations. The set of operations includes generating area information indicating each area of each image of a plurality of images, the plurality of images being projected onto a projection surface. The set of operations includes detecting one or more areas that are designated by a user operation out of a plurality of areas, the plurality of areas based on the area information that is generated. The set of operations also includes selecting a portion of the plurality of areas based on the one or more areas that are detected.

According to the present technology, there is provided an information processing apparatus including a display and a display control circuitry. The display control circuitry is configured to generate area visualization information that visually indicates each area of each image of a plurality of images, the plurality of images being projected onto a projection surface, control the display to display the area visualization information overlaid on the plurality of images projected on the projection surface, receive an indication of one or more areas being designated by a user operation with respect to the area visualization information overlaid on the plurality of images projected on the projection surface, and control the display to differentiate a display of the one or more areas from the display of the area visualization information overlaid on the plurality of images projected on the projection surface.

According to the present technology, there is provided an information processing apparatus including: an area information generating unit that generates area information indicating each area of a plurality of images which are projected to a projection surface; a detection unit that detects an area which is designated by a user operation out of a plurality of areas presented on the basis of the area information; and an area selecting unit that selects at least some areas of the plurality of areas on the basis of the area detected by the detection unit. Further, in the information processing apparatus according to an embodiment of the present technology, the plurality of images may be a plurality of images which are captured at different times and arranged in a time series.

The information processing apparatus according to an embodiment of the present technology may further include an image generating unit that generates a mapping image by performing a mapping process using images corresponding to the areas selected by the area selecting unit out of the plurality of images. Further, in the information processing apparatus according to an embodiment of the present technology, the mapping process may be a process of associating and combining a plurality of images which are captured at different times and arranged in a time series to generate the mapping image.

In the information processing apparatus according to an embodiment of the present technology, the area selecting unit may perform a process of selecting areas for a mapping process on the basis of the areas which are detected by the detection unit and which are individually designated by the user operation.

In the information processing apparatus according to an embodiment of the present technology, the area selecting unit may perform a process of selecting the areas which are detected by the detection unit and which are individually designated by the user operation as the areas which are used for the mapping process.

In the information processing apparatus according to an embodiment of the present technology, the area selecting unit may perform a process of selecting the areas which are detected by the detection unit and which are individually designated by the user operation as areas which are excluded from use for the mapping process.

In the information processing apparatus according to an embodiment of the present technology, the area selecting unit may perform a process of selecting areas for a mapping process on the basis of the areas which are detected by the detection unit and which are designated as continuous areas by the user operation.

In the information processing apparatus according to an embodiment of the present technology, the area selecting unit may perform a process of selecting areas for the mapping process on the basis of a designation start area and a designation end area which are detected by the detection unit and which are designated by the user operation.

In the information processing apparatus according to an embodiment of the present technology, the area selecting unit may perform a process of selecting areas for the mapping process on the basis of a designation end area which is detected by the detection unit and which is designated by the user operation.

In the information processing apparatus according to an embodiment of the present technology, the area selecting unit may perform a process of selecting areas for the mapping process on the basis of a designation start area which is detected by the detection unit and which is designated by the user operation.

In the information processing apparatus according to an embodiment of the present technology, the area selecting unit may perform a process of selecting areas for the mapping process on the basis of areas which are detected by the detection unit and which correspond to a user's condition designating operation.

In the information processing apparatus according to an embodiment of the present technology, designation of an area based on a condition of a height at which an imaging device is located at the tine of capturing an image may be able to be performed as the condition designating operation.

In the information processing apparatus according to an embodiment of the present technology, designation of an area based on a condition of change in height of a position of an imaging device at the time of capturing an image may be able to be performed as the condition designating operation.

In the information processing apparatus according to an embodiment of the present technology, designation of an area based on a condition of an imaging orientation of an imaging device at the time of capturing an image may be able to be performed as the condition designating operation.

In the information processing apparatus according to an embodiment of the present technology, the area information may include information of an outline of an area of an image which is projected to the projection surface.

According to the present technology, there is provided an information processing method that an information processing apparatus performs: a generation step of generating area information indicating each area of a plurality of images which are projected to a projection surface; a detection step of detecting an area which is designated by a user operation out of a plurality of areas presented on the basis of the area information; and an area selecting step of selecting at least some areas of the plurality of areas on the basis of the area detected in the detection step.

According to the present technology, there is also provided an information processing apparatus including a display control unit which is configured to perform: a process of displaying area visualization information for visually displaying each area of a plurality of images which are projected to a projection surface; and a process of displaying at least some areas of a plurality of areas on the basis of designation of an area by a user operation on display using the area visualization information.

In the information processing apparatus according to an embodiment of the present technology, a process of displaying a mapping image which is generated using an image corresponding to an area selected on the basis of designation of the area by the user operation may be performed.

### Advantageous Effects of Invention

According to the present technology, it is possible to provide an information processing apparatus, an information processing method, and a program that enable performing a mapping process on the basis of a user's determination.

Incidentally, the advantageous effects described herein are not restrictive and any advantageous effect described in the present technology may be achieved.

### BRIEF DESCRIPTION OF DRAWINGS

FIG. 1 is an explanatory diagram illustrating a state in which a farm field is imaged according to an embodiment of the present technology.

FIG. 2 is an explanatory diagram illustrating an area selection image according to the embodiment.

FIG. 3 is an explanatory diagram illustrating a mapping image according to the embodiment.

FIG. 4 is a block diagram of an imaging device and a sensor box according to the embodiment.

FIG. 5 is a block diagram of an information processing apparatus according to the embodiment.

FIG. 6 is a block diagram illustrating a functional configuration of the information processing apparatus according to the embodiment.

FIGS. 7A and 7B are explanatory diagrams illustrating image data and a variety of detection data according to the embodiment.

FIGS. 8A to 8D are explanatory diagrams illustrating information of selection/non-selection of images according to the embodiment.

FIGS. 9A and 93 are explanatory diagrams illustrating selection of areas using an area selection image according to the embodiment.

FIG. 10 is an explanatory diagram illustrating a mapping image which is generated after selection of areas according to the embodiment.

FIG. 11 is a block diagram illustrating another example of the functional configuration of the information processing apparatus according to the embodiment.

FIG. 12 is a flowchart illustrating a control process according to a first embodiment.

FIG. 13 is a flowchart illustrating an area selection-related process according to the embodiment.

FIG. 14 is a flowchart illustrating an area selection-related process according to the embodiment.

FIG. 15 is a flowchart illustrating an area selection-related process according to the embodiment.

FIG. 16 is an explanatory diagram illustrating an area selection image in which imaging points are set to be non-displayed according to the embodiment.

FIG. 17 is an explanatory diagram illustrating an area selection image in which frames of projection surfaces are set to be non-displayed according to the embodiment.

FIG. 18 is an explanatory diagram illustrating an area selection image in which excluded areas are set to be translucent according to the embodiment.

FIG. 19 is an explanatory diagram illustrating an area selection image in which excluded areas are set to be non-displayed according to the embodiment.

FIG. 20 is an explanatory diagram illustrating an area selection image in which areas are painted according to the embodiment.

FIG. 21 is an explanatory diagram illustrating an area selection image in which areas are painted according to the embodiment.

FIG. 22 is an explanatory diagram illustrating display of a pop-up at the time of area designation according to the embodiment.

FIG. 23 is an explanatory diagram illustrating display of a pop-up at the time of excluded area designation according to the embodiment.

FIG. 24 is an explanatory diagram illustrating display of a pop-up at the time of range designation according to the embodiment.

FIG. 25 is an explanatory diagram illustrating display of a pop-up at the time of range designation according to the embodiment.

FIG. 26 is an explanatory diagram illustrating display at the time of start designation according to the embodiment.

FIG. 27 is an explanatory diagram illustrating display of a pop-up at the time of end designation according to the embodiment.

FIG. 28 is an explanatory diagram illustrating display at the time of condition designation according to the embodiment.

FIG. 29 is an explanatory diagram illustrating display at the time of condition designation according to the embodiment.

FIG. 30 is an explanatory diagram illustrating display before an exclusion designation according to the embodiment.

FIG. 31 is an explanatory diagram illustrating display after a designated area is excluded according to the embodiment.

FIG. 32 is an explanatory diagram illustrating display after a previous area is excluded according to the embodiment.

FIG. 33 is an explanatory diagram illustrating display after a subsequent area is excluded according to the embodiment.

FIG. 34 is a flowchart illustrating a control process according to a second embodiment.

### Description of Embodiments

Hereinafter, embodiments will be described in the following contents.
<1. Area Selection Image and Mapping Image in Remote Sensing>
<2. Apparatus Configuration>
<3. First Embodiment>
[3-1: Entire Processes]
[3-2: Area Selection-Related Process]
<4. Second Embodiment>
<5. Third Embodiment>
<6. Conclusion and Modified Examples>

### 1. Area Selection Image and Mapping Image in Remote Sensing

In embodiments, it is assumed that a vegetation state of a farm field is sensed.

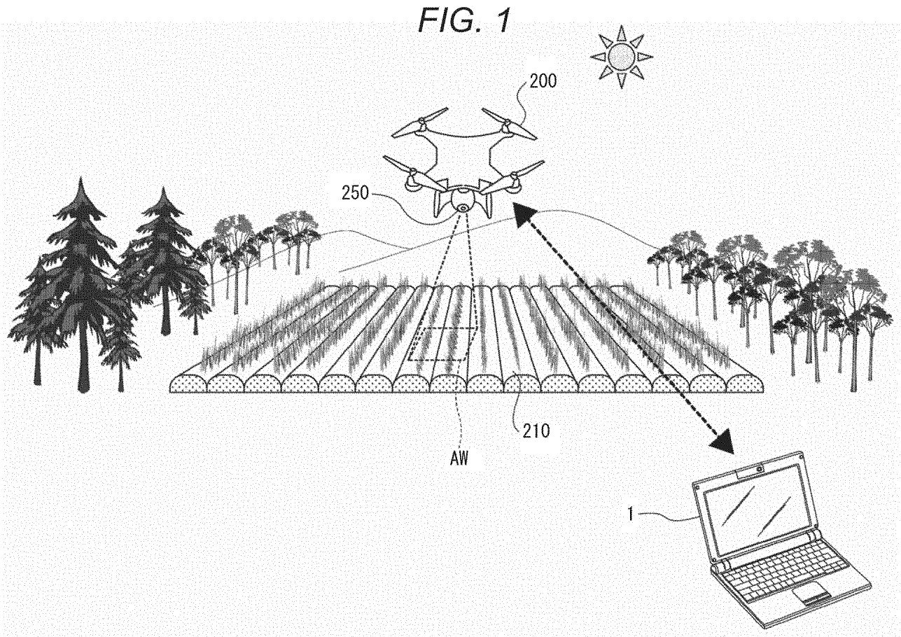

For example, as illustrated in FIG. 1, remote sensing associated with vegetation of a farm field 210 is performed using an imaging device 250 that is mounted in a flying object 200 such as a drone. In addition, a mapping image indicating vegetation data (for example, data of vegetation indices) is generated using a plurality of pieces of image data (also simply referred to as “images”) acquired by the imaging.

FIG. 1 illustrates an appearance of a farm field 210. A small flying object 200 can move above the farm field 210, for example, by an operator's radio control, automatic radio control, or the like.

In the flying object 200, for example, an imaging device 250 is set to capture an image below. When the flying object 200 moves above the farm field 210 along a predetermined route, the imaging device 250 can acquire an image of a capture-viewing field range AW at each time point, for example, by periodically capturing a still image.

The flying object 200 flies along a predetermined flying route in accordance with a flight plan which is recorded in advance, and the imaging device 250 captures an image every predetermined time from flight start to flight end. In this case, the imaging device 250 correlates images which are sequentially acquired in a time series with position information, orientation information, or the like which will be described later.

A plurality of images in a series which are captured in this way are associated and arranged in a time series. This series of images is a plurality of images which are associated as a target of a mapping process.

It is considered that various types of imaging devices car. be used as the imaging device 250.

For example, spectroscopic images may be included in an image file (a captured image at a certain time point) which his acquired by capturing an image with the imaging device 250. That is, the imaging device 250 may be a multi-spectrum camera and a measured image having information of two or more specific wavelength bands may be included as a captured image thereof.

Further, a camera that captures a visible light image of R (a red wavelength band of 620 nm to 750 nm), G (a green wavelength band of 495 nm to 570 nm) , and B (a blue wavelength band of 450 nm to 495 nm) may be used as the imaging device 250.

Further, a camera that can acquire a captured image of a red wavelength band (RED of 620 nm to 750 nm) and a near infrared band (NIR of 750 nm to 2500 nm) and that can calculate a normalized difference vegetation index (NDVI) from the acquired image may be used as the imaging device 250. The NDVI is an index indicating distribution or activities of vegetation.

Note that the value of the HDVI which is vegetation data and is one vegetation index can be calculated by the following equation using RED image data and NIR image data.

NDVI=(1−RED/MIR)/(1+RED/NIR)

Further, an image which is captured and acquired by the imaging device 250 is correlated with various types of additional data.

Additional data includes information which is detected by various sensors (collectively referred to as “sensor data” in this description), device information of the imaging device 250, captured image information regarding a captured image, and the like.

Specifically, sensor data includes data such as imaging date and time information, position information (latitude/longitude information) which is global positioning system (GPS) data, height information, and imaging orientation information (a tilt of an imaging direction in a state in which the imaging device is mounted in the flying object 200). Accordingly, sensors that detect imaging date and time information, position information, height information, imaging orientation information, and the like are mounted in the flying object 200 or the imaging device 250.

Examples of device information of the imaging device 250 include individual identification information of the imaging device, model information, camera type information, a serial number, and maker information. Captured image information includes information such as an image size, a codec type, a detection wavelength, and an imaging parameter.

The additional data including image data which is acquired by the imaging device 250 mounted in the flying object 200 or sensor data which is acquired by various sensors in this way is sent to an information processing apparatus (a computer apparatus) 1. The information processing apparatus 1 performs various processes using the image data or the sensor data. For example, the information processing apparatus performs a process of generating a mapping image of NDVI or a process of displaying the mapping image. The information processing apparatus also displays a user interface for selecting an image in a previous step of the mapping process, for example.

The information processing apparatus 1 is embodied by, for example, a personal computer (PC), a field-programmable gate array (FPGA), or the like.

Note that, in FIG. 1, the information processing apparatus 1 is separated from the imaging device 250, but a computing apparatus (a microcomputer or the like) serving as the information processing apparatus 1 may be provided in a unit including the imaging device 250.

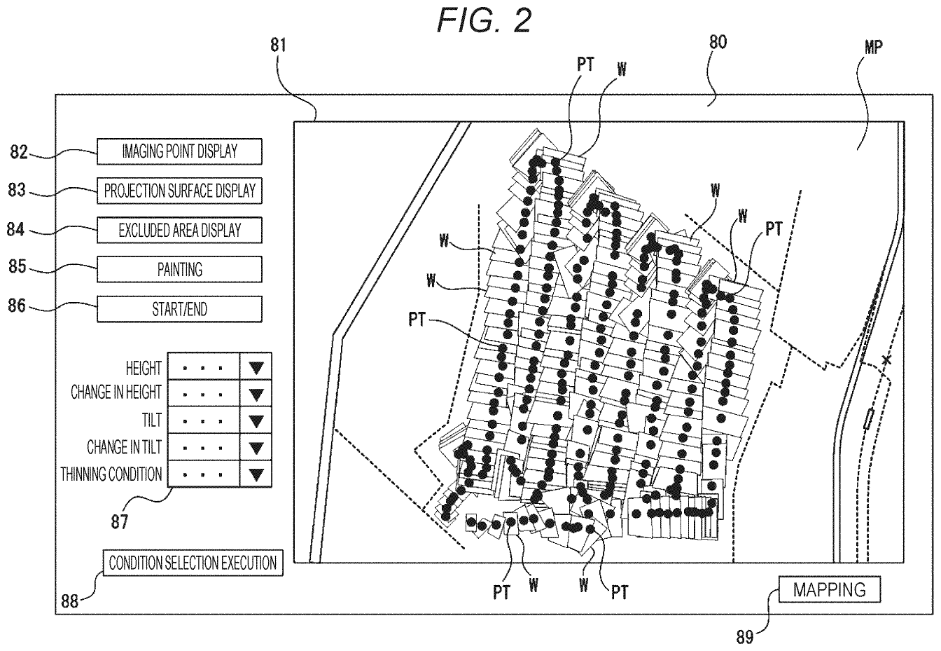

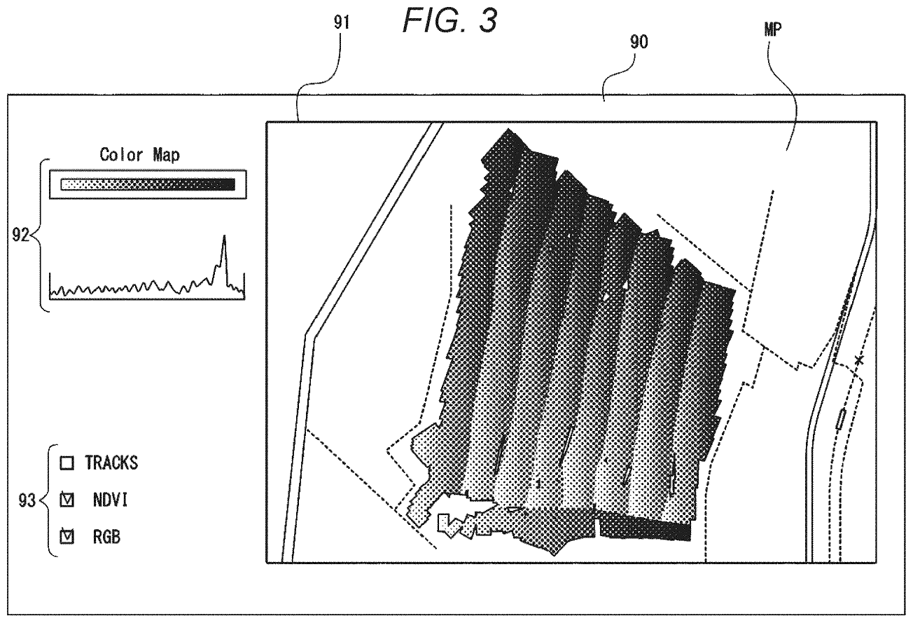

In the information processing apparatus 1, display of an area selection image 81 illustrated in FIG. 2, display of a mapping image 91 illustrated in FIG. 3, and the like are performed.

FIG. 2 illustrates an example of an area selection Interface image 80.

The area selection interface image 80 is presented to a user in a previous step of a mapping image generating process and enables the U3er to perform an operation of designating an image which is used to generate a mapping image 91.

The area selection image 81 is displayed in the area selection interface image 80.

The area selection image 81 clearly displays areas of each of captured image data which are projected to an image plane, for example, to overlap a map image MP. That is, an outline of an area of each image which is projected to a projection surface is displayed as a frame W.

The projection surface is, for example, a plane in which each of image data is projected, arranged, and displayed and is a horizontal plane for expressing an image including a range such as a farm field 210. That is, a two-dimensional plane in which ranges of each of images are expressed on a plane by projecting individual image data thereto on the basis of position information or orientation information at the time of imaging in order to generate a mapping image is defined as the projection surface.

Note that the projection surface is described as a plane, but is not limited to a plane and may be a curved surface, a spherical surface, or the like.

When the above-mentioned remote sensing is performed, the imaging device captures a plurality of images while moving above a farm field 210. Accordingly, as illustrated in FIG. 2, a plurality of frames W indicating projection areas of each of the images are displayed.

For example, when the imaging device periodically captures an image at intervals of a predetermined time in a period in which the flying object 200 flies along a predetermined flying route from taking-off to landing, frames W corresponding to each of the captured images are sequentially arranged in a time series. In the drawing, an example in which images are captured to cover almost the whole farm field 210 by capturing an image while flying above the farm field 210 in a zigzag is illustrated.

The shape of each frame W is an area (a captured range) indicated by each corresponding image and the shape of the frame W is not fixed but is various.

When an imaging direction (a viewing direction) of the imaging device 250 mounted m the flying object 200 is continuously kept downward, an area (a captured area range) to which a captured image is projected is rectangular (it is assumed that a pixel array of an image sensor of the imaging device is rectangular).

The orientation of the flying object 200 is not kept horizontal but varies during flying and a height thereof is not fixed. The relative imaging direction of the imaging device 250 mounted in the flying object 200 may vary. A subject distance at each pixel position may vary depending on undulation of a land as the farm field 210 or a vegetation state. Accordingly, the shapes or sizes of each of the frames W corresponding to each of images are various.

Further, an imaging point PT corresponding to each image is displayed in the area selection image 81. The imaging point PT is displayed on the basis of position information of the imaging device 250 at an imaging time point of the image. That is, the imaging point PT is coordinate information corresponding to an imaging position during flying.

When the imaging device 250 captures an image just below, the imaging point PT is displayed to be located at the center of a rectangular frame W of the captured image. However, the imaging direction of the imaging device 250 varies during flying and the imaging device 250 often captures an image below obliquely, the position of the imaging point PT is not necessarily the center of the corresponding frame Vi. For example, when the tilt of the orientation of the flying object 200 is large, the imaging point PT may be located at a position deviating from the corresponding frame W.

From the area selection image 81 in which a frame W and an imaging point PT appear to correspond to each image in this way, a user can ascertain a range in which images are acquired by capturing an image above the farm field 210.

Further, by superimposing frames W on a map image MP, it is possible to ascertain a range on a map in which images are acquired. For example, it is also possible to ascertain whether imaging can be performed to cover the whole range of the farm field 210, whether imaging can be performed to cover a specific range, or the like. Incidentally, in this example, a map image MP is used as the background, but the map image MP may be an aerial photo image or a geometric image other than a so-called map.

Further, the map image MP may not be used as the background. For example, the frames W or the imaging points PT may be conspicuous using a plain background, a background of a specific color, or the like.

Further, a user can also select an image which is used to generate the mapping image 91 (or an image which is excluded from use in generating the mapping image 91) by displaying each area of the captured images using the frames W and the imaging points PT in the area selection image 81.

For the purpose of ascertainment of a user or a designation operation, an operation of designating a frame W or an imaging point PT on the area selection image 81 is possible in the area selection interface image 80 or various operators (operation buttons/icons) are provided therein.

For example, designation of a specific imaging point PT or a specific frame W, a range designating operation, or the like is possible on the area selection image 81 by a clicking operation using a mouse, a touch operation, or the like.

Furthermore, although will be described later, various operations in which a pop-up menus is displayed based on designation are possible.

Further various operators can be used along with such designation operations.

An imaging point display button 82 is an operator for switching ON/OFF of display of the imaging points PT on the area selection image 81.

A projection surface display button 83 is an operator for switching ON/OFF of display of the frames W indicating projection surfaces on the area selection image 81.

An excluded area display button 84 is an operator for switching ON/OFF of display of the frames W (and the imaging points PT) corresponding to images which are not used to generate a mapping image 91 by a user operation. A painting button 85 is an operator for instructing execution/end of painting display of each frame W.

A start/end button 86 is an operator which is used for a user to perform an area designating operation through start designation and end designation.

A condition setting unit 87 is provided to set various conditions in which are used for a user to designate an area. For example, the condition setting unit 87 can set a condition of a height, a condition of change in height, a condition of a tilt, a condition of change in tilt, a thinning condition, and the like.

In the condition of a height, for example, conditions such as a height of (x) m or greater, a height less than (x) m, inside a range from a height of (x) m to (y) m, and outside a range from a height of (x) m to (y) m may be set for the height at which imaging is performed (a height from the ground surface).

In the condition of change m height, an area is designated depending on the magnitude of the change in height. For example, a degree of change in height may be selected by selecting a threshold value for a differential value of the height at each imaging time point. For example, a user can designate an image (an area) with a small degree of change in height or select that the condition of change in height is not designated. In the condition of a tilt, for example, conditions such as (x) degrees or greater, less than (x) degrees, inside a range from (x) degrees to (y) degrees, and outside a range from (x) degrees to (y) degrees may be set for the tilt of the orientation (for example, an angle with respect to the horizontal direction) of the flying object 200 (the imaging device 250).

In the condition of change in tilt, an area is designated depending on the magnitude of change in orientation. For example, a degree of change in tilt may be selected by selecting a threshold value for a differential value of the tilt value at each imaging time point. For example, a user can designate an image (an area) with a small degree of change in tilt or select that the condition of change in tilt is not designated.

The thinning condition is, for example, a condition for regularly thinning an image (an area). For example, conditions such as intervals of odd numbers or even numbers, a third image, and a fourth image may be set. A condition selection execution button 88 is an operator for instructing to designate an image (an area) under the condition set by the condition setting unit 87. Incidentally, designation of an image based on the set condition is performed by an area selecting unit 12. However, in order to select an image depending on the condition of a height and the condition of a tilt which are input to the condition setting unit 87 by a user, the area selecting unit 12 refers to information of the height or the tilt which is associated with each image. In addition, depending on whether or not they corresponds to the conditions designated by input to the condition setting unit 87, whether or not each image satisfies the conditions is determined.

Further, when the condition of change in height and the condition of change in tilt are designated, the area selecting unit 12 calculates differential values (change values from an immediately previous time point) of height information and tilt information for each image and determines whether or not they correspond to the conditions designated by input to the condition setting unit 87.

A mapping button 89 is an operator for instructing to generate a mapping image using working images (areas) in response to a user's designation operation which has been performed by the above-mentioned operators, a touch operation, a mouse operation, or the like.

Incidentally, the user's operation using the area selection interface image 80 is to designate an area indicated by a frame W, and the information processing apparatus 1 generates a mapping image 91 on the basis of the designation operation. The user's designation of an area (a frame W) means that an image corresponding to the area is designated. Accordingly, the operation of designating an area can also be said to be an operation of designating an image.

Further, the user's designation operation may be an operation of designating an area (an image) which is used to generate a mapping image 91 or may be an operation of designation an excluded area (an excluded image) which is not used to generate a mapping image 91.

FIG. 3 illustrates an example of a mapping image 91. A mapping image 91 is generated using images of areas which are selected on the basis of a user operation using the area selection interface image 80 illustrated in FIG. 2 and a vegetation observation image 90 is displayed as illustrated in FIG. 3. The mapping image 91 is included in the vegetation observation image 90.

The mapping image 91 is generated, for example, as an image in which a vegetation state in a predetermined range is expressed in colors as an NDVI image by performing a mapping process on images which are selected to be used. Note that, since an NDVI image is difficult to display in the drawing, the mapping image 91 is very schematically illustrated.

A color map 92 represents ranges of colors which are expressed on the mapping image 91 and an area distribution of areas which are expressed in each of the colors.

In a check box 93, for example, “TRACKS,” “NDVI,” and “RGB” can be checked. “TRACKS” refers to display indicating a track of flight (an image capturing route), “NDVI” refers to display of an NDVI image, and “RGB”refers to display of an RGB image. A user can arbitrarily turn on/off the displays using the check box 93.

### 2. Apparatus Configuration

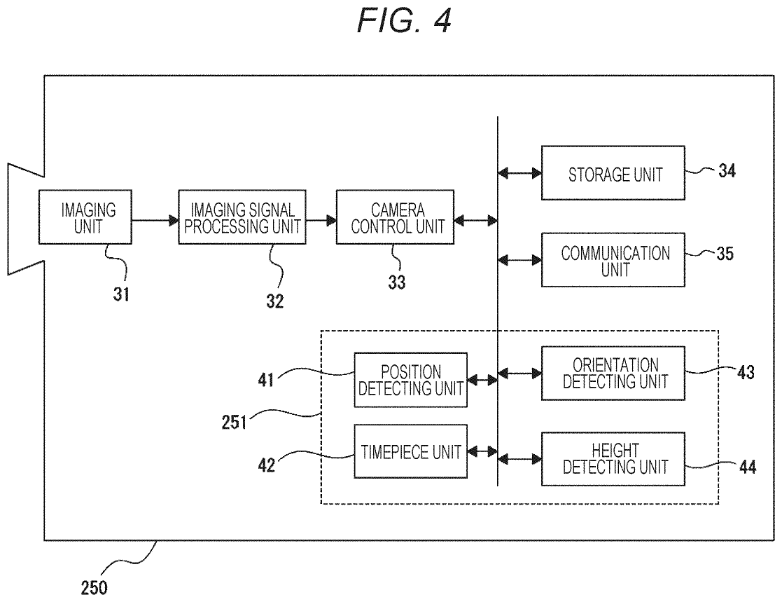

FIG. 4 illustrates an example of a configuration of the imaging device 250 which is mounted in a flying object 200.

The imaging device 250 includes an imaging unit 31, an imaging signal processing unit 32, a camera control unit 33, a storage unit 34, a communication unit 35, and a sensor unit 251.

The imaging unit 31 includes an imaging lens system, an exposure unit, a filter, an image sensor, and the like, receives subject light, and outputs a captured image signal as an electrical signal.

That, is, in the imaging unit 31, light (reflected light) from a subject such as a measurement object is incident on the image sensor via the lens system and the filter. The lens system refers to an incident optical system including various lenses such as an incidence lens, a zoom lens, a focus lens, and a condensing lens.

The filter is a filter that extracts a measurement wavelength for a measurement object. This includes a color filter which is generally provided on the image sensor, a wavelength filter which is disposed before the color filter, and the like.

The exposure unit refers to a part that performs exposure control by adjusting an aperture of an optical system such as the lens system or an iris (an aperture diaphragm) such that sensing is performed in a state in which signal charge is not saturated but is in a dynamic range.

The image sensor has a configuration including a sensing element in which a plurality of pixels are two-dimensionally arranged in a repeated pattern on a sensor surface thereof.

The image sensor outputs a captured image signal corresponding to light intensity of light to the imaging signal processing unit 32 by detecting light passing through the filter using the sensing element.

The imaging signal processing unit 32 converts the captured image signal output from the image sensor of the imaging unit 31 into digital data by performing an AGC process, an A/D conversion process, and the like thereon, additionally performs various necessary signal processing thereon, and outputs the resultant signal as image data of a measurement object to the camera control unit 33. For example, image data of an RGB color image is output as the image data of a measurement object to the camera control unit 33. Alternatively, for example, when a captured image of a red wavelength band (RED) and a near infrared band (NIR) is acquired, RED image data and NIR image data are generated and output to the camera control unit 33.

The camera control unit 33 is constituted, for example, by a microcomputer and controls the whole operations of the imaging device 250 such as an imaging operation, an image data storing operation, and a communication operation.

The camera control unit 33 performs a process of storing image data sequentially supplied from the imaging signal processing unit 32 in the storage unit 34. At this time, various types of sensor data acquired by the sensor unit 251 are added to the image data to form an image file and the resultant is stored in the storage unit 34. Alternatively, a file in which the sensor data is correlated with the image data may be stored.

Examples of the storage unit 34 include a flash memory as an internal memory of the imaging device 250, a portable memory card, and the like. Other types of storage media may be used.

The communication unit 35 transmits and receives data to and from an external device by wired or wireless communication. For example, the data communication may be wired communication based on a standard such as universal serial bus (USB) or may be communication based on a radio communication standard such as Bluetooth (registered trademark) or WI-FI (registered trademark). Image data and the like stored in the storage unit 34 car. be transmitted to an external device such as the information processing apparatus 1 by the communication unit 35.

Incidentally, when the storage unit 34 is a portable memory card or the like, the stored data may be delivered to the information processing apparatus 1 and the like by handing over a storage medium such as a memory card.

The sensor unit 251 includes a position detecting unit 41, a timepiece unit 42, an orientation detecting unit 43, and a height detecting unit 44.

The position detecting unit 41 is, for example, a so-called GPS receiver and can acquire information of latitude and longitude as a current position.

The timepiece unit 42 counts a current time.

The orientation detecting unit 43 is a sensor that detects a flying orientation of the flying object 200, for example, a tilt with respect to the horizontal direction or the vertical direction, by a predetermined algorithm, for example, using an inertial measurement unit (IMU) including a three-axis gyro and acceleration meters in three directions. This sensor directly or indirectly detects a tilt of an imaging direction of the imaging device 250 (for example, an optical axis direction of the incident optical system of the imaging unit 31).

The height detecting unit 44 detects a height from the ground surface to the flying object 200, that is, a height of an imaging place.

For example, by mounting the sensor unit 251 including such sensors, the camera control unit 33 can correlate image data at each time point with position information acquired by the position detecting unit 41, date and time information acquired by the timepiece unit 42, tilt information acquired by the orientation detecting unit 43, or height information acquired by the height detecting unit 44 to form a file.

The information processing apparatus 1 side can ascertain a position, a time, an orientation, and a height at the time of capturing each image by acquiring the detection data along with image data.

Incidentally, the height detecting unit 44 may detect, for example, a height above sea level and it is preferable that a height from the ground surface (for example, the farm field 210) at the imaging position be calculated and stored as the height information which is correlated with the captured image,

Incidentally, in FIG. 4, the imaging device 250 has the sensor unit 251 incorporated thereinto, but, for example, a sensor box including the position detecting unit 41, the timepiece unit 42, the orientation detecting unit. 43, the height detecting unit 44, and the like may be mounted in the flying object 200 separately from the imaging device 250 and transmit detection information to the imaging device 250.

Further, the sensors are only examples. In addition, the sensor unit 251 may additionally include other sensors such as an illuminance sensor and a temperature sensor and correlate detected values thereof with the image data

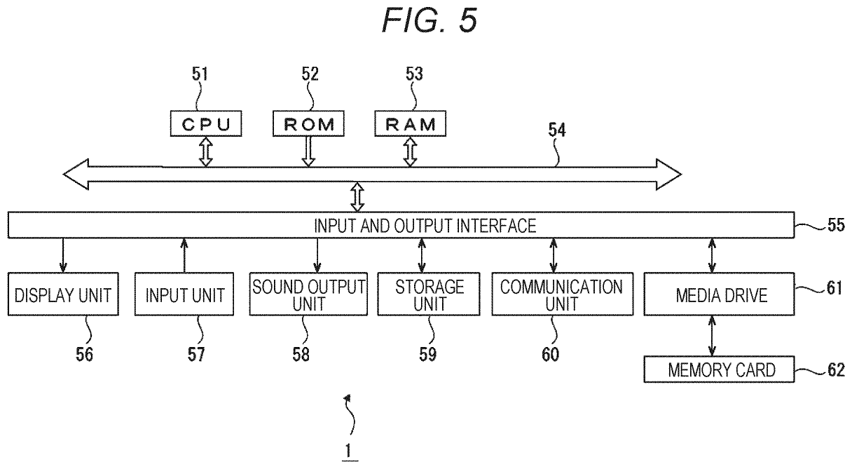

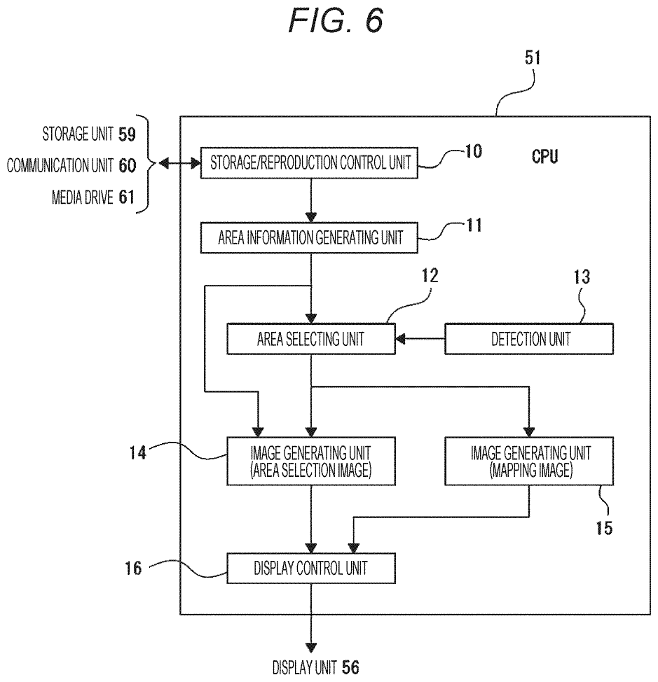

The configuration of the information processing apparatus 1 will be described below with reference to FIGS. 5 and 6 FIG. 5 illustrates an example of a hardware configuration of the information processing apparatus 1 which is embodied by a PC or the like.

As illustrated in FIG. 5, the information processing apparatus 1 includes a central processing unit (CPU) 51, a read only memory (ROM) 52, a random access memory (RAM) 53.

The CPU 51 performs various processes in accordance with a program stored in the ROM 52 or a program which is loaded from a storage unit 59 into the RAM 53. Further, data necessary for the CPU SI to perform various processes and the like are appropriately stored in the RAM 53.

The CPU 51, the ROM 52, and the RAM 53 are connected to each other via a bus 54. Further, an input and output interface 55 is also connected to the bus 54.

A display unit 56, an input unit 57, a sound output unit 58, a storage unit 59, a communication unit 60, a media drive 61, and the like can also be connected to the input and output interface 55.

The display unit 56 is configured as a display device including a liquid crystal display panel or an organic electroluminescence (EL) display panel and a drive circuit of the display panel. The display unit 56 may be integrated with the information processing apparatus 1 or may be a device which is separated therefrom.

The display unit 56 performs, for example, display of a captured image or a combined image, display of an evaluation index, and the like.

Particularly, in this embodiment, the area selection interface image 80 illustrated in FIG. 2 or the vegetation observation image 90 illustrated in FIG. 3 is displayed on the display unit 56.

The input unit 57 refers to an input device that is used by a user who uses the information processing apparatus 1. Examples of the input device include a keyboard and a mouse. Not limited thereto, for example, a touch panel which is integrated with the display unit 56, a touch pad, and a gesture input device that includes an imaging device, detects a user's behavior, and recognizes an operation input, a sight line input device that detects a user's line of sight, and the like can also be used as the input device.

The sound output unit 58 includes a speaker, a power amplifying unit that drives the speaker, and the like and outputs necessary sound.

The storage unit 59 includes, for example, a hard disk drive (HDD) and the like and stores various types of data or programs. For example, a program for realizing functions which will be described later with reference to FIG. 6 is stored in the storage unit 59. Further, image data acquired by the imaging device 250 or various types of additional data is also stored in the storage unit 59 and thus a process of displaying various images using the image data becomes possible.

The communication unit 60 performs communication process via a network including the Internet, or communication with peripheral devices. The information processing apparatus 1 can download various programs through network communication or transmit image data and other data to an external device by the communication unit 60.

Further, the communication unit 60 may perform wired or wireless communication with the communication unit 35 of the imaging device 250. Accordingly, image data captured by the imaging device 250 and the like can be acquired. Incidentally, the communication unit 60 may sequentially perform wireless communication during imaging by the imaging device 250 and receive and acquire image data and the like or may receive and acquire data at each of the time points together after imaging has ended.

Further, if necessary, the media drive 61 is connected to the input and output interface 55, a memory card 62 is attached thereto, and writing and reading of information to and from the memory card 62 is possible.

For example, a computer program read from the memory card 62 is installed in the storage unit 59 if necessary. Further, for example, when a memory card 62 to which image data or the like is written in the imaging device 250 is attached to the media drive 61, the image data or the like can be read and stored in the storage unit 59. Incidentally, the media drive 61 may be a recording and reproduction drive for a removable storage medium such as a magnetic disk, an optical disk, and a magneto-optical disk.

In the information processing apparatus 1 according to this embodiment, the CPU 51 has the functions illustrated in FIG. 6 in such a hardware configuration.

That is, in the CPU 51, a storage and reproduction control unit 10, an area information generating unit 11, an area selecting unit 12, a detection unit 13, an image generating unit 14, an image generating unit 15, and a display control unit 16 are provided as functions which are realized in software.

The storage and reproduction control unit 10 is, for example, a function that performs storage of data or control of a reproduction operation on the storage unit 59, the media drive 61, and the like.

Particularly, the storage and reproduction control unit 10 is mentioned as a function for performing a process using image data captured by the imaging device 250 and additional data including various types of detection data. The storage and reproduction control unit 10 may transmit and receive data to and from the communication unit 60.

The area information generating unit 11 performs a process of generating area information indicating each of areas of a plurality of images which are projected to a projection surface. An image is image data captured by the imaging device 250.

Area information may be information of spatial coordinates or functions indicating a range which is imaged in image data and is specifically information for displaying frames W or imaging points PT indicating areas corresponding to each of images.

As described above, the information processing apparatus 1 captures a farm field 210 as illustrated in FIG. 1, performs a mapping process on a series of image data which are associated to be arranged in a time series, and generates a mapping image 91. The information processing apparatus 1 performs a process of selecting images to be subjected to the mapping process on the basis of a user operation for the purpose thereof.

The area information generating unit 11 generates area information indicating areas of each of the images (areas as ranges of imaged places) to generate the area selection interface image 80 which is used for the selection. Particularly, the area information generating unit 11 generates information of frames (frames W) or imaging positions (imaging points PT) indicating the areas.

The information of each frame W includes position information of an area indicated by an outline shape thereof.

The information of each imaging point PT is, for example, position information which is acquired at the imaging time point.

The image generating unit 14 generates the area selection interface image 80 including an area selection image 81 which is used for a user to perform an operation of designating an area (that is, an image) using the area information.

The detection unit 13 detects an area designated by the user operation out of a plurality of areas (frames W) which are presented by the area selection image 81 on the basis of the area information.

The user can perform an operation of designating each area by an operation input using the input unit 57 in a state in which the area selection image 81 is displayed on the display unit 56. The detection unit 13 detects the designation operation.

The area selecting unit 12 performs a process of setting at least some areas of the plurality of areas as areas which are used to generate the mapping image 91 on the basis of the areas (areas designated by the user) detected by the detection unit 13 and selecting images corresponding to the areas.

The image generating unit 15 performs a mapping process using the images selected by the area selecting unit 12 and performs a process of generating the mapping image 91. For example, the image generating unit 15 generates the mapping image 91 as an NDVI image. Examples of the specific mapping method include stitch and ortho mapping.

The display control unit 16 performs control for displaying the area selection interface image 80 including the area selection image 81 generated by the image generating unit 14 or the vegetation observation image 90 including the mapping image 91 generated by the image generating unit 15 on the display unit 56.

Although a specific processing example will be described later, the processes in the information processing apparatus according to an embodiment of the present technology are performed, for example, by causing the CPU 51 of the information processing apparatus 1 having the configuration illustrated in FIG. 5 to include the functions illustrated in FIG. 6 in hardware or in software, particularly, to include at least the area information generating unit 11, the area selecting unit 12, and the detection unit 13.

When the functions illustrated in FIG. 6 are embodied in software, a program constituting the software may be downloaded from a network or read from a removable storage medium and is installed in the information processing apparatus 1 illustrated in FIG. 5. Alternatively, the program nay be stored in advance in an HDD serving as the storage unit 59 or the like. In addition, by causing the CPU 51 to start the program, the above-mentioned functions are realized.

Note that the information processing apparatus 1 according to this embodiment is not limited to a single computer (information processing apparatus) 150 having the hardware configuration illustrated in FIG. 5, but may be configured by systemizing a plurality of computers. A plurality of computers may be systemized by a local area network (LAN) or the like or may be disposed at remote positions by a virtual private network (VPN) or the like using the Internet or the like. The plurality of computers may include a computer which can be used by a cloud computing service.

Further, the information processing apparatus 1 illustrated in FIG. 5 can be embodied by a personal computer such as a stationary type or a notebook type or a mobile terminal such as a tablet, terminal or a smartphone. Furthermore, the functions of the information processing apparatus 1 according to this embodiment can also be mounted in an electronic apparatus such as a measuring device, an imaging device, a television device, a monitor device, or a facility management device having the function of the information processing apparatus 1.

Forms of image data acquired from the imaging device 250 and various types of additional data which are correlated with the image data will be described below. As described above, the additional data includes various types of detection information, imaging device information, image information, and the like.

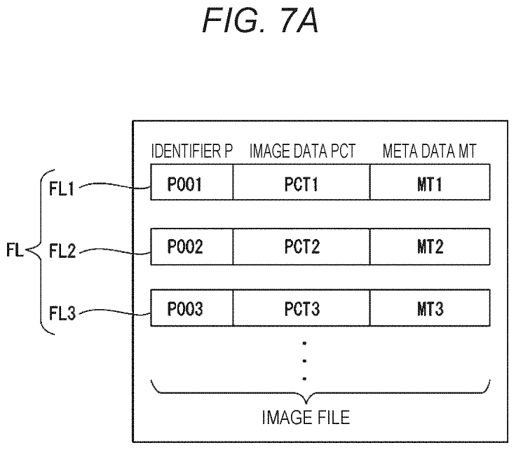

For example, FIG. 7A illustrates an example in which various types of additional data are correlated as meta data attached to an image file.

One image corresponds to one image file FL (a file name such as FL1, FL2, FL3, . . . ).

Each image file FL includes an identifier P (P001, P002, P003, . . . ), image data PCT (PCT1, PCT2, PCT3, . . . ), meta data MT (MT1, MT2, MT3, . . . ) in a predetermined file format.

For example, an image file FL1 includes an identifier P001, image data PCT1, and meta data MT1. The identifier P001 is, for example, a unique identifier which is added to the image data PCT1. In this embodiment, for example, a plurality of images which are captured by at least one time of flight have each unique identifiers. The image data PCT1 is image data which is actually captured. The meta data MT1 is additional data corresponding to the image data PCT1, that is, sensor data such as a time, a position, a height, and an orientation at the time of capturing the image data PCT1, device information of the imaging device 250, captured image information, and the like. Similarly, the image file FL2 also includes an identifier P002, image data PCT2, and meta data MT2.

In this way, by correlating the image data PCT with additional data including meta data MT arid sensor data from various sensors of the sensor unit 251, the information processing apparatus 1 side can recognize position information, height information, orientation information, and time information for the image data PCT

FIG. 7B illustrates an example in which image data and sensor data are formed as separate files.

For example, an image file FL (a file name FL1, FL2, FL3, . . . ) includes an identifier E, image data PCT, and meta data MT. For example, it is assumed that the meta data MT includes device information, captured image information, and the like and does not include sensor data.

In addition, a sensor data file SFL (a file name SFL1, SFL2, SFL3, . . . ) is provided and has a file structure including an identifier P and sensor data SD (SD1, SD2, SD3, . . . ). Position information, height information, orientation information, tine information, and the like are described as the sensor data SD.

The sensor data file SFL has, for example, the same identifier P as the corresponding image file FL, or the sensor data files SFL and the image files FL are correlated with each other by the correspondence. Accordingly, the information processing apparatus 1 side can recognize position information, height information, orientation information, and time information for the image data PCT.

This example is a data format which can be employed when the sensor box having the configuration of the sensor unit 251 is provided separately from the imaging device 250 and the sensor box forms the files.

For example, as for an image data PCT of each image file FL which is exemplified in FIG. 7A or 7B, each imaging range (each projected area) on the area selection image 81 illustrated in FIG. 2 is expressed by a frame W.

In addition, areas (images) which are used for the mapping image 91 are selected from each of the areas (that is, each of the images) expressed by the frames W as illustrated in FIG. 2 on the basis of a user's designation operation.

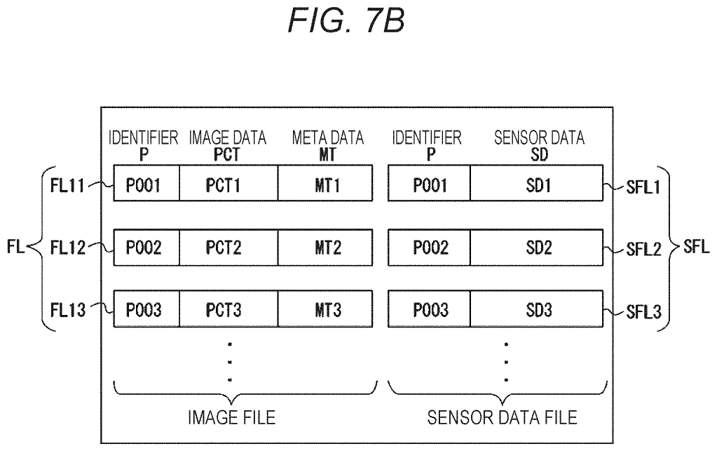

Accordingly, in the information processing apparatus 1, a selection flag based on the user's designation operation is managed for each area (image) expressed by a frame W. This will be described below with reference to FIGS. 8A to 8D.

FIG. 8A illustrates a state in which selection flags Fsel are managed to correspond to identifiers P (P001, P002, P003, . . . ) of each of the image files.

For example, as for the selection flags Fsel, it is assumed that Fsel=0 indicates an “image used for mapping” and Fsel=1 indicates an “excluded image not used for mapping.”

For example, by performing an operation of a specific area which is represented by a frame W or an imaging point PT by the operation on the area selection interface image 80 illustrated in FIG. 2, a user can exclude the specific area (image) from the mapping process or add the specific area to the mapping process.

For example. FIG. 8A illustrates an initial state, where it is assumed that all captured images are images which are used for mapping and the selection flags thereof are set to Fsel=0.

Here, when the user performs a designation operation of excluding the areas of the images with the identifiers P001 and P002 from the mapping, the selection flags thereof are switched to Fsel=1 as illustrated in FIG. 8B.

Further, FIG. 8C illustrates a state in which images with the identifiers P001 to P004 are excluded and the selection flags thereof are set to Fsel=1. When the user performs an operation of designating the images to be images which are used for mapping, the selection flags thereof are switched to Fsel=0 as illustrated in FIG. 8D.

The information processing apparatus 1 performs a mapping process using image data with the selection flag of Fsel=0 which is managed for each image data.

As a result, a mapping process based on a user's selection of images is realized.

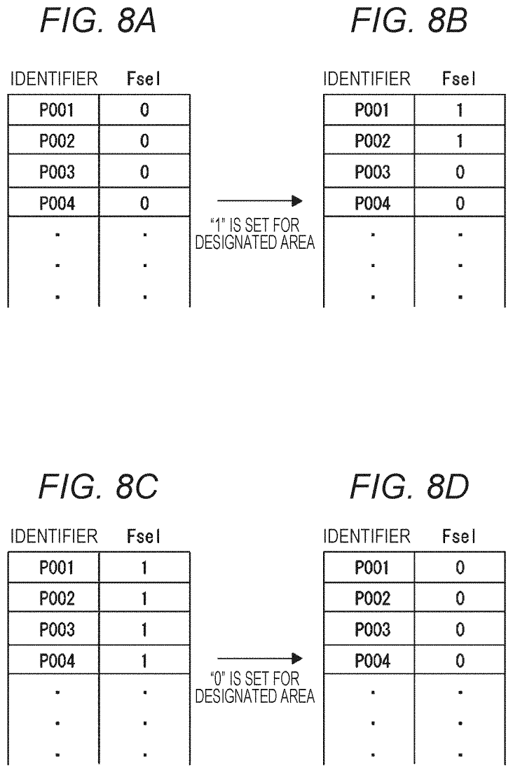

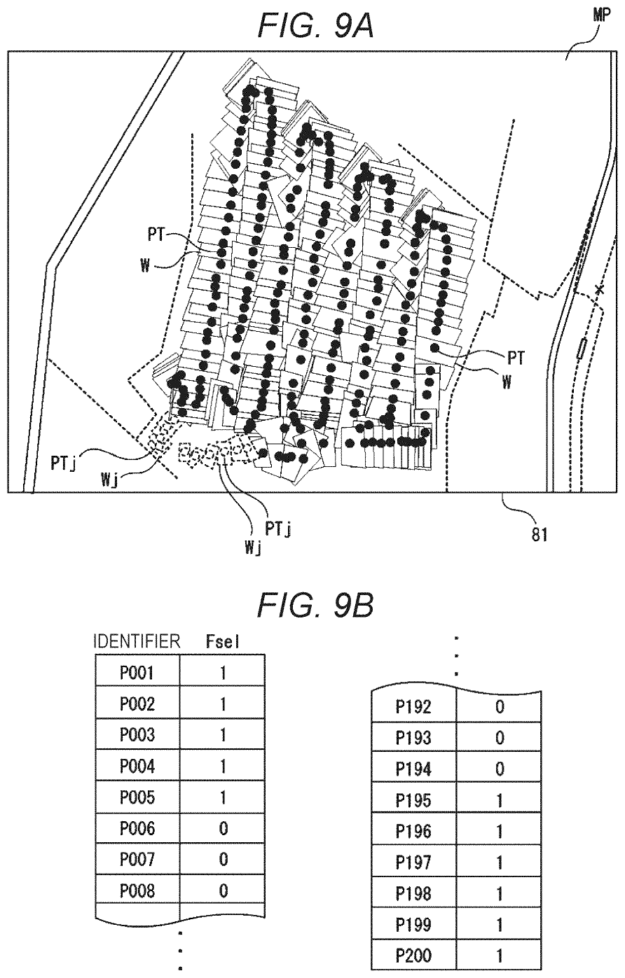

A specific example will be described below with reference to FIGS. 9 to 10. Incidentally, in the following description, an image or an area of which the selection flag is set to Fsel=0 and which is selected as being used for mapping may be referred to as a “working image” or a “working area.” An image or an area of which the selection flag is set to Fsel=1 and which is not selected as being used for mapping may be referred to as an “excluded image” or an “excluded area.”

Here, it is assumed that all areas are set to working images in the initial state of the area selection image 81 illustrated in FIG. 2. In this state, it is assumed that a user designates some areas as excluded areas. On the area selection image 81, areas designated by the user represent excluded areas and a display form thereof is changed as illustrated in FIG. 9A. For example, a working area is displayed to be opaque by a solid line (a frame W and an imaging point PT) and an excluded area is displayed to be translucent, thin, broken line, or the like (a frame Wj and an imaging point PTj).

Further, when this designation has been performed, the selection flag Fsel for an image corresponding to an area which is an excluded area is set to Fsel=1 as illustrated in FIG. 9B. Incidentally, in FIG. 9B, it is assumed that the total number of areas (the number of captured images) is 200, and the identifiers P corresponding to each of the areas are illustrated as identifiers P001 to P200.

When it is instructed to generate a mapping image 91 in this state, the generation process is performed using only the images of which the selection flags are set to Fsel=0.

In the example illustrated m FIG. 9A, it is assumed that some images from the head of a time series captured from a time point at which the flying object 200 starts flight are excluded images and some images after a time point at which the flying object 200 starts landing are excluded images. The mapping image 91 which is generated in this case is as illustrated in FIG. 10. That is, the mapping image is an image in which areas in a period in which flight is started or in a landing period are not included. Incidentally, in FIG. 10, the imaging points PTj in the excluded areas are displayed, but such imaging points PTj may not be displayed.

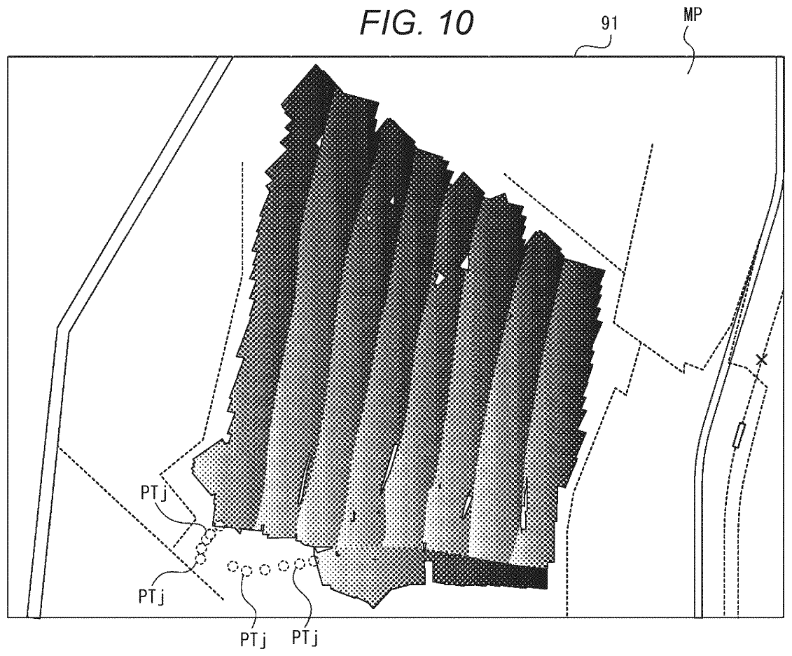

Meanwhile, the functional configuration illustrated in FIG. 6 for performing the above-mentioned display operation is an example and, for example, a functional configuration illustrated in FIG. 11 can also be considered.

This illustrates functional configurations of the CPU 51 of the information processing apparatus 1 and a CPU 51A of an information processing apparatus 1A, for example, on the assumption that the information processing apparatus 1 that presents the area selection interface image 80 and an information processing apparatus (referred to as an “information processing apparatus 1A”) that performs a mapping process and presents a mapping image 91 are separate from each other.

Incidentally, regarding a hardware configuration, for example, the information processing apparatus 1A can be assumed to have the same configuration as illustrated in FIG. 5 similarly to the information processing apparatus

As illustrated in FIG. 11, the CPU 51 includes, for example, a storage and reproduction control unit 10, an area information generating unit 11, an area selecting unit 12, a detection unit 13, an image generating unit 14, and a display control unit 16 as functions which are embodied in software. These functions are basically similar to FIG. 6.

Here, the display control unit 16 is a function of performing display control, and has a function of displaying an area selection interface image 60 including an area selection image 81 generated by the image generating unit 14 in this case.

Further, the storage and reproduction control unit 10 receives information of working areas or excluded areas selected by the area selecting unit 12, and performs a process of transmitting the information of working areas or excluded areas, image data, or the like to the information processing apparatus 1A via the communication unit 60 or storing the information, the image data, or the like in a storage medium such as a memory card via the media drive 61.

The information processing apparatus 1A acquires information such as image data from the information processing apparatus 1 by handing the memory card 62 over or by wired or wireless communication, network communication, or the like. In the CPU 51A of the information processing apparatus 1A, the storage and reproduction control unit 10, the image generating unit 14, and the display control unit 16 are provided as functions which are embodied in software.

Similarly to the storage and reproduction control unit 10 of the CPU 51, the storage and reproduction control unit 10 is a function of storage of data or control of a reproduction of data with respect to the storage unit 59, the media drive 61, and the like or transmit or receive data to and from the communication unit 60. Here, in the case of CPU 51A, the storage and reproduction control unit 10 performs a process of acquiring image data which is used for a mapping process. That is, the storage and reproduction control unit 10 acquires an image which is selected in the information processing apparatus 1 and of which the selection flag is set to Fsel=0.

Alternatively, the storage and reproduction control unit 10 may acquire all images and the selection flags Fsel of each of the images. The storage and reproduction control unit 10 of the CPU 51A has only to acquire image data which is used for a mapping process.

The image generating unit lb is a function of performing a process of generating a mapping image 91 in the similar way as described above with reference to FIG. 6.

The display control unit 16 is a function of performing display control, and has a function of displaying a vegetation observation image 90 including the mapping image 91 generated by the image generating unit 15 in this case.

By employing the configuration illustrated in FIG. 11, for example, a system in which a plurality of computers are used as the information processing apparatuses 1 and 1A, the information processing apparatus 1 performs a process of selecting working images which are used to generate the mapping image 91, and the information processing apparatus 1A performs the mapping process and presentation of the mapping image 91 can be realized. Incidentally, the example of the functional configuration is not limited to the example illustrated in FIGS. 6 and 11. Various configuration examples can be considered. Further, the information processing apparatus 1 may additionally has a function of controlling the flying object 200, a function of communicating with the imaging device 250, another interface function, and the like.

### 3. First Embodiment

[3-1: Entire Processes]

Hereinafter, a process example of the CPU 51 of the information processing apparatus 1 according to a first embodiment will be described on the assumption of the configuration example illustrated in FIG. 6.

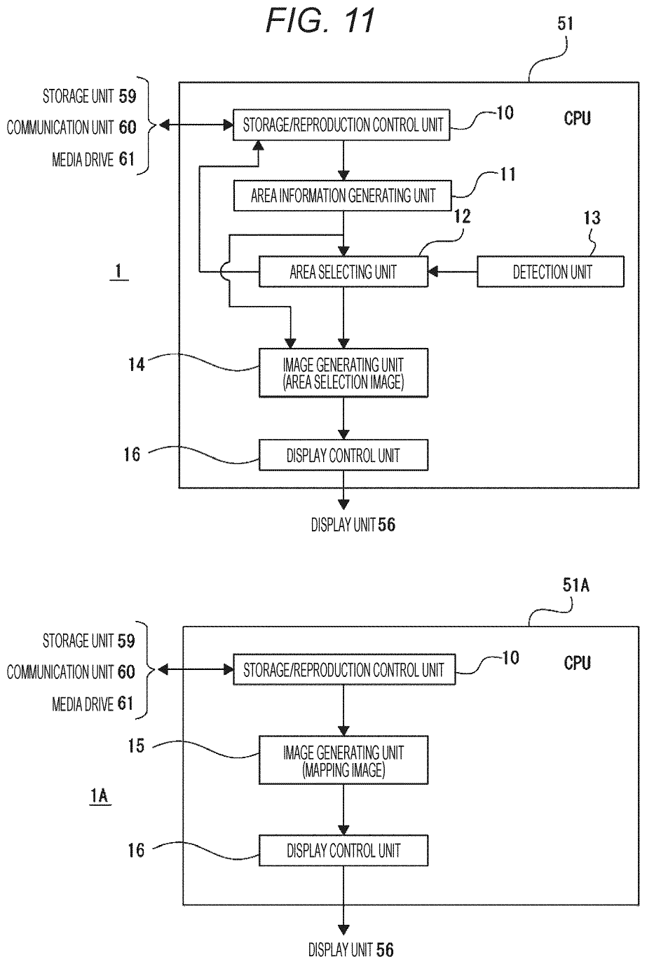

The process flow illustrated in FIG. 12 is based on the assumption that the information processing apparatus 1 displays an area selection interface image 80 in a state in which a plurality of pieces of image data and additional data which are captured by the imaging device 250 by one time of flight have been delivered to the information processing apparatus 1 via a storage medium or by communication. The CEU 51 performs the following process flow according to the functions illustrated in FIG. 6.

In Step S101 of FIG. 12, the CPU 51 generates area information of areas to which captured images are projected. Area information is, for example, information of frames W or imaging points PT.

In Step S102, the CPU 51 performs display control of an area selection image 81. Specifically, the CPU 51 performs control for displaying an area selection interface image 80 including the area selection image 81 (see FIG. 2) on the display unit 56.

In a period in which the area selection interface image 80 is displayed, the CPU 51 monitors a user's operation. That is, the CPU 51 monitors an instruction operation for area selection or display of an area selection image in Step S103. In the example illustrated in FIG. 2, the CPU 51 monitors a designation operation for the area selection image 31 by clicking with a mouse, a touch, or the like or an operation of the imaging point display button 82, the projection surface display button 83, the excluded area display button 84, the painting button 85, the start/end button 86, the condition setting unit 87, and the condition selection execution button 88. Other operations can be considered, but the operations on the area selection image 81, which is an operation other than an instruction to generate a mapping image 91 with the mapping button 89, is monitored.

Although will be described later, the CPU 51 may display a pop-up menu in response to a certain operation, and such an operation of displaying a pop-up menu is detected as the instruction operation in Step S103.

The CPU 51 also monitors an instruction to generate a mapping image 91 using the mapping button 89 in Step S105. Note that, actually, an end operation, a setting operation, and various other operations are possible, but operations which are not directly associated with the present technology will not be described.

In a period in which an operation is not detected in Step S103 or S105, the CPU 51 continues to perform the process of Step S102, that is, to perform display control of the area selection interface image 80.

When an instruction operation is detected in Step S103, the CPU 51 performs a process (an area selection-related process) corresponding to the operation on the area selection image 81 in Step S104. The area selection-related process includes a process associated with display of the area selection image 81 or a process of selecting a working area in the areas appearing in the area selection image 81. A specific process example thereof will be described later.

When an operation of instructing to generate a mapping image 91 is detected in Step S105, the CPU 51 performs a process of generating the mapping image 91 using images (selected images) which are selected as working areas at that time in Step S106.

Then, the CPU 51 performs display control of the mapping image 91 in Step S107. That is, the CPU 51 performs a process of displaying a vegetation observation image 90 (see FIG. 3) on the display unit 56. Accordingly, a user of the information processing apparatus 1 can ascertain a vegetation state from the mapping image 91 in which images selected from the captured images are used.

[3-2: Area Selection-Related Process]

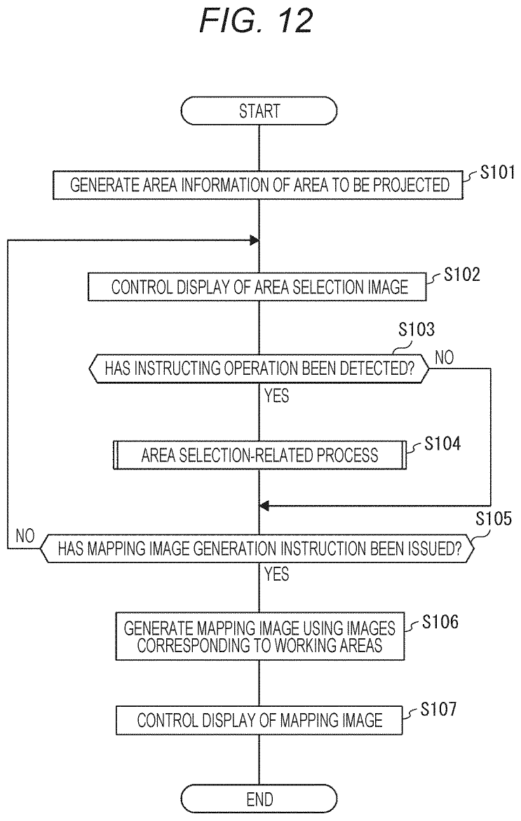

An example of the area selection-related process of Step S104 in FIG. 12 is illustrated in FIGS. 13, 14, and 15. The CPU 51 performs processes corresponding to various instruction operations as the area selection-related process. Note that FIGS. 13, 14, and 15 are successive as indicated by “D2” and “D3” and a flowchart of a series of processes of Step S104 is divided and illustrated in three drawings. The CPU 51 determines a type of the instruction operation detected in Step S103 of FIG. 12 in Steps S201, S202, S203, S204, S205, S206, S207, S208, and S209 in FIGS. 13, 14, and 15.

When the process flow progresses to Step S104 by performing an operation of the imaging point display button 82, the process flow progresses from Step S201 to Step S211 of FIG. 13 and the CPU 51 ascertains whether or not imaging points PT are currently displayed on the area selection image 81.

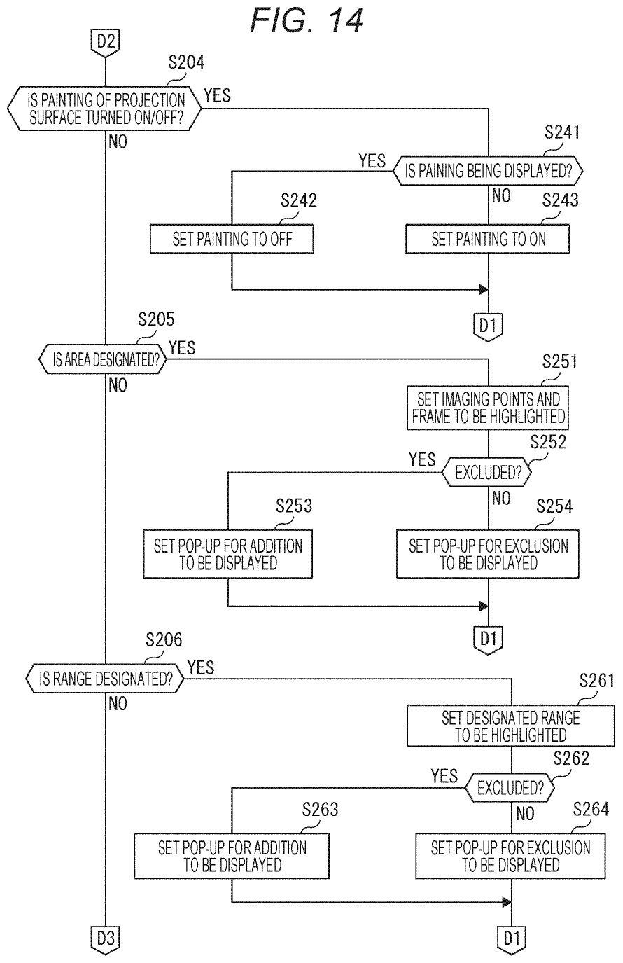

For example, the imaging points PT are displayed on the area selection image 81 in FIG. 2. In this display state, the CPU 51 sets the imaging points PT to be non-displayed in Step S212. Then, as indicated by “D1,” the process flow progresses to the tail of FIG. 15 and the CPU 51 ends the area selection-related process (S104).

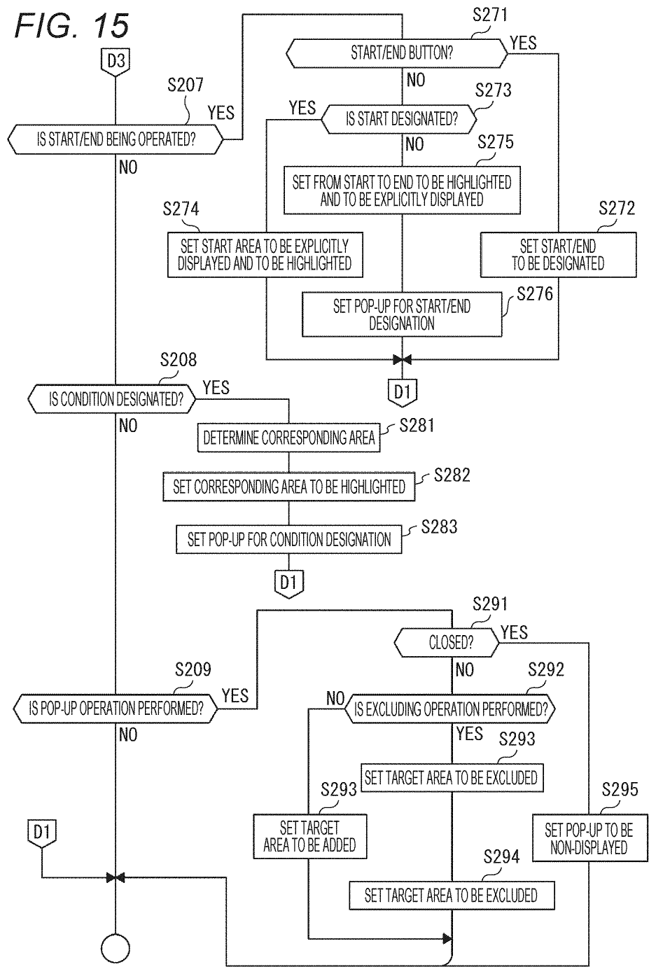

In this case, by setting the imaging points PT to be non-displayed, the CPU 51 performs control such that the imaging points PT are not displayed on the area selection image 81 in Step S102 of FIG. 12 subsequent thereto. As a result, the imaging points PT are not displayed on the area selection image 81 as illustrated in FIG. 16. Accordingly, the user can ascertain the areas of the images using only the frames W. For example, this is a display form which is convenient when the imaging points PT are much crowded.

When it is determined in Step S211 of FIG. 13 that the imaging points PT are not currently displayed on the area selection image 81, the CPU 51 sets the imaging points PT to be displayed in Step S213. Then, as indicated by “D1,” the process flow progresses to the tail of FIG. 15 and the CPU 51 ends the area selection-related process (S104). This is, for example, a process when an operation of the imaging point display button 82 has been performed in the display state illustrated in FIG. 16. In this case, by setting the imaging points PT to be displayed, the CPU 51 performs control such that the imaging points PT are displayed on the area selection image 81 in Step S102 of FIG. 12 subsequent thereto. As a result, the area selection image 81 is returned to, for example, a state in which the imaging points PT are displayed as illustrated in FIG. 2.

By performing the above-mentioned control, a user can set the imaging points PT to be non-displayed on the area selection image 81 or to be displayed again using the imaging point display button 82.

When the process flow progresses to Step S104 of FIG. 12 by performing an operation of the projection surface display button 83, the process flow progresses from Step S202 to Step S221 of FIG. 13 and the CPU 51 ascertains whether or not frames W are currently displayed on the area selection image 81.

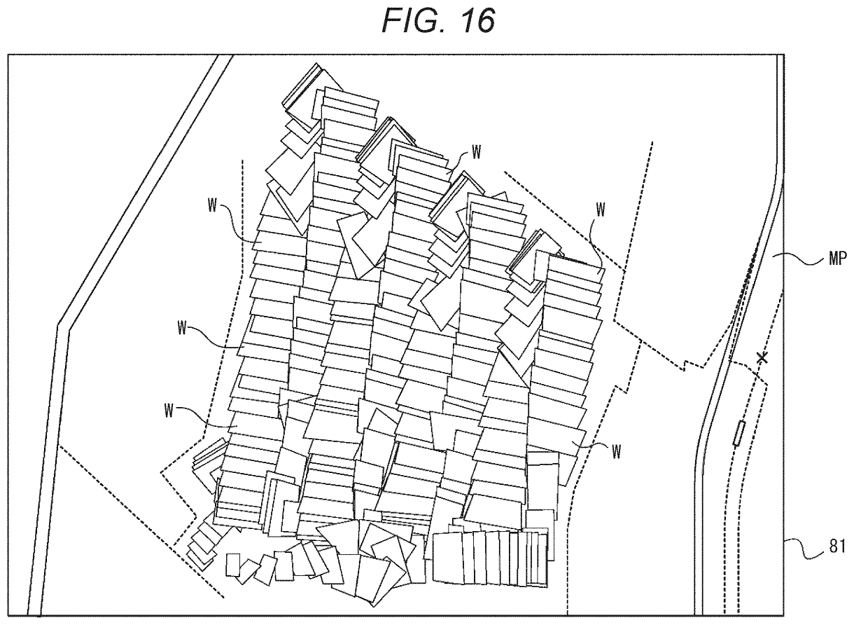

For example, in FIG. 2, the frames W of each of the areas are displayed on the area selection image 81. In this display state, the CPU 51 sets the frames W to be non-displayed in Step S222. Then, as indicated by “D1,” the process flow progresses to the tail of FIG. 15 and the CPU 51 ends the area selection-related process (S104). In this case, by setting the frames W to be non-displayed, the CPU 51 performs control such that the frames W are not displayed on the area selection image 81 in Step S102 of FIG. 12 subsequent thereto. As a result, the frames W are not displayed on the area selection image 81 as illustrated in FIG. 17. Accordingly, the user can ascertain the areas of the images using only the imaging points PT. For example, this is a display form which is convenient when it is intended to ascertain change of an imaging position.

When it is determined in Step S221 of FIG. 13 that the frames W are not currently displayed on the area selection image 81, the CPU 51 sets the frames W to be displayed in Step S223. Then, as indicated by “D1,” the process flow progresses to the tail of FIG. 15 and the CPU 51 ends the area selection-related process (S104). This is, for example, a process when an operation of the projection surface display button 83 has been performed in the display state illustrated in FIG. 17.

In this case, by setting the frames W to be displayed, the CPU 51 performs control such that the frames W are displayed on the area selection image 81 in Step S102 of FIG. 12 subsequent thereto. As a result, the area selection image 81 is returned to, for example, a state in which the frames W are displayed as illustrated in FIG. 2.

By performing the above-mentioned control, the user can set the frames W indicating an outline of each of the areas to be non-displayed on the area selection image 81 or to be displayed again using the projection surface display button 83.

When the process flow progresses to Step S104 of FIG. 12 by performing an operation of the excluded area display button 84, the process flow progresses from Step S203 to Step S231 of FIG. 13 and the CPU 51 ascertains whether or not excluded areas are currently displayed on the area selection image 81.

An area which is designated to be an excluded area by a user operation, a frame W or an imaging point PT thereof is, for example, displayed to be translucent, displayed in different colors, displayed to be thin, or displayed by a broken line such that it is distinguished from a working area. This is an example in which an excluded area is displayed to be less conspicuous with respect to a working area.

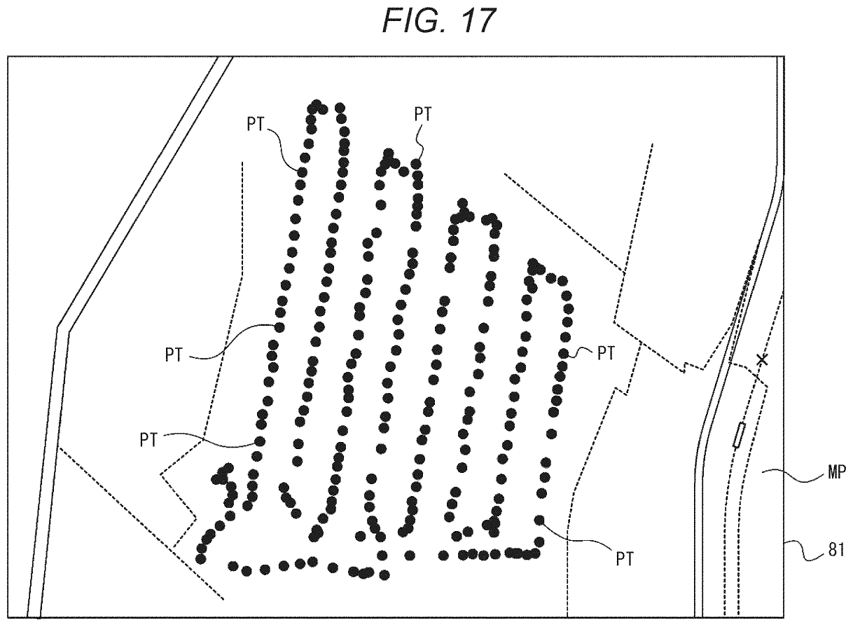

For example, in FIG. 18, frames W or imaging points PT of some areas are displayed by a broken line such that they are less conspicuous than the working areas (a frame of an excluded area is indicated by “Wj” and an imaging point is indicated by “PTj”).

For example, in the display state in which the frames Wj or the imaging points PTj of the excluded areas are currently displayed as illustrated in FIG. 18, the CPU 51 sets the frame Wj or the imaging points PTj of the excluded areas to be non-displayed in Step S232. Then, as indicated by “D1, ” the process flow progresses to the tail of FIG. 15 and the CPU 51 ends the area selection-related process (S104).

In this case, the CPU 51 performs control such that the frames Wj or the imaging points PTj of the excluded areas are not displayed on the area selection image 81 in Step S102 of FIG. 12 subsequent thereto. As a result, as illustrated in FIG. IS, parts illustrated as the frames Wj or the imaging points PTj of the excluded areas in FIG. 18 are not displayed on the area selection image 81. Accordingly, the user can easily ascertain whether or not the mapping image 91 of a target range can be generated using only the areas currently designated as working areas.

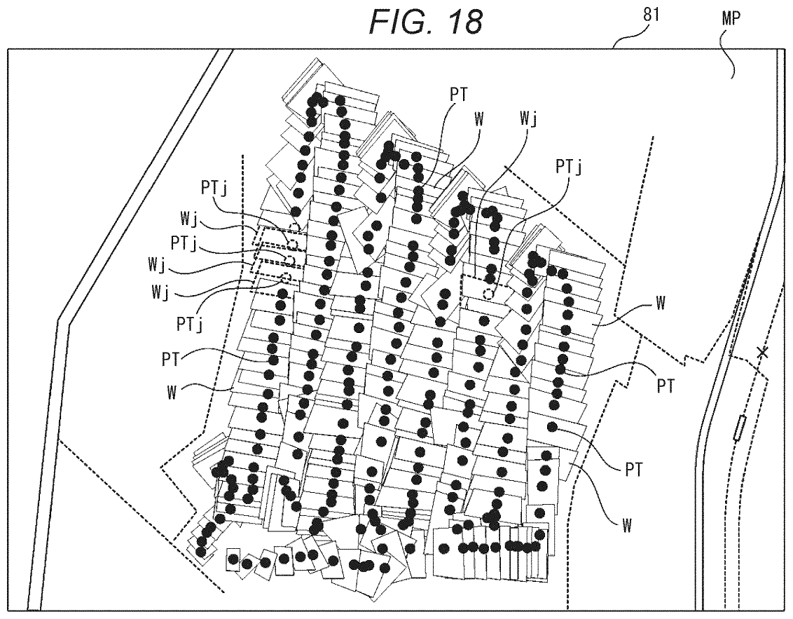

When it is determined in Step S231 of FIG. 13 that the frames Wj or the imaging points PTj of the excluded areas are not currently displayed on the area selection image 81 as illustrated in FIG. 19, the CPU 51 sets the frames Wj or the imaging points PTj of the excluded areas to be displayed .in Step S233. Then, as indicated by “D1,” the process flow progresses to the tail of FIG. 15 and the CPU 51 ends the area selection-related process (S104). In this case, in Step S102 of FIG. 12 subsequent thereto. the CPU 51 performs control such that the frames Wj or the imaging points PTj of the excluded areas are displayed on the area selection image 81. As a result, the area selection image 81 is changed, for example, from the example illustrated in FIG. 19 to the example illustrated in FIG. 18.

By performing the above-mentioned control, the user can set the excluded areas to be non-displayed on the area selection image 81 or to be displayed again using the excluded area display button 84.

Incidentally, in a normal state, display may be performed such that an excluded area is more conspicuous than a working area. Particularly, in order to easily understand an operation of designating an excluded area, a designated area frame Wj is displayed to be highlighted or the like. Even when such display is performed, display of an excluded area can be turned on/off according to the operation of the excluded area display button 84.

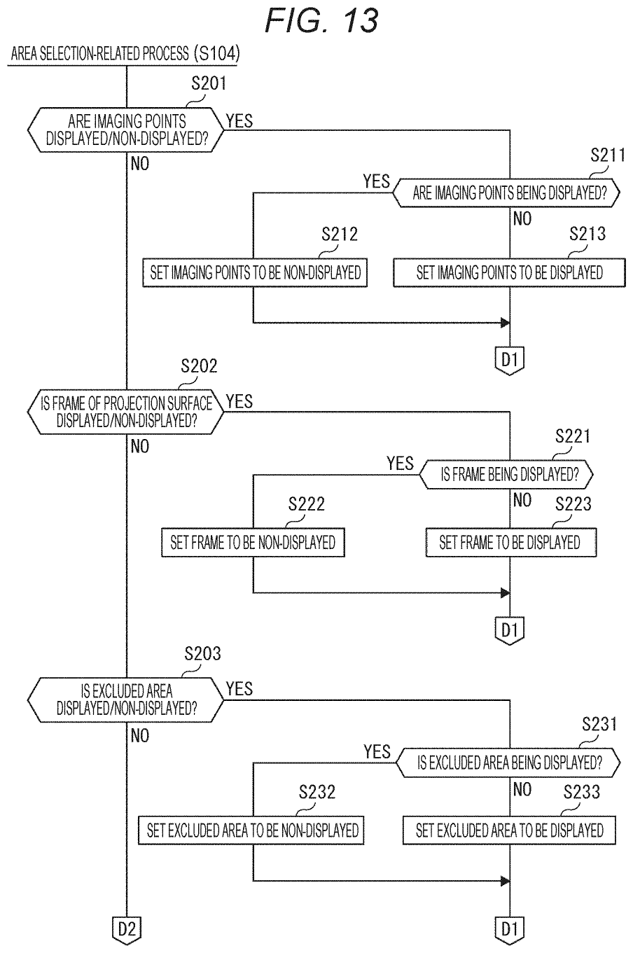

When the process flow progresses to Step S104 of FIG. 12 by performing an operation of the painting button 85, the process flow progresses from Step S204 to Step S241 of FIG. 14 and the CPU 51 ascertains whether or not painted areas are currently displayed on the area selection image 81.

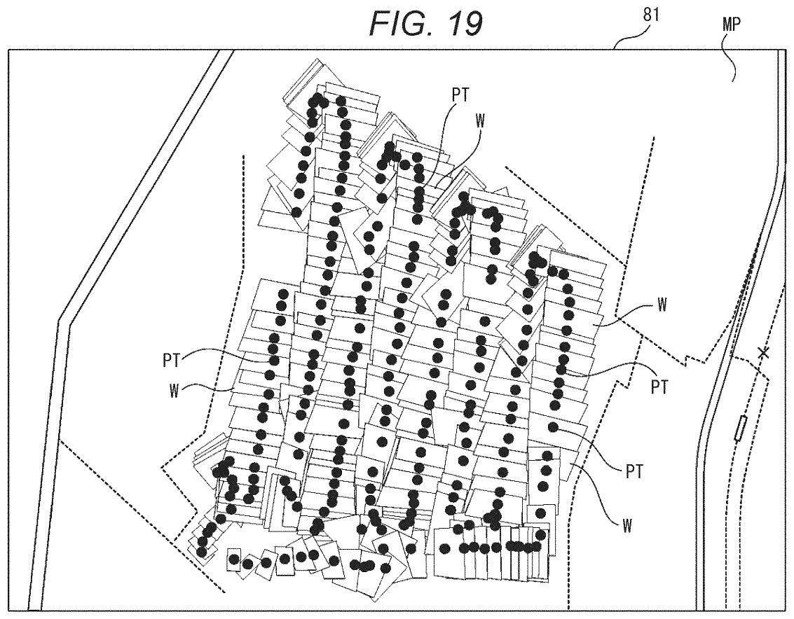

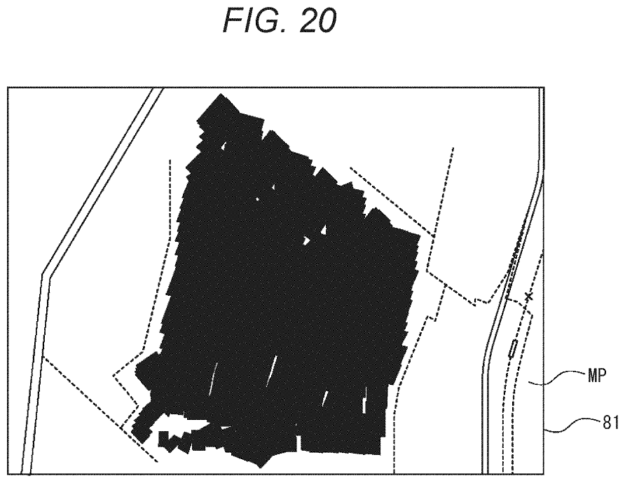

Painted display means that an inside of an outline indicated by all the frames W is painted, and a painted display state is illustrated, for example, in FIG. 20. The painted range can be said to be a range which is covered by at least one image. For example, a part of the painted range in FIG. 20 is enlarged in FIG. 21, and there may be a blank area AE which is not painted. This area is an area which is included in no frame W. That is, blank area AE is an area which is not covered by any image.

Images around a blank area AE which cause the blank area AE are images of which imaged ranges are not sufficiently superimposed and which are not suitable for combination by mapping.

Accordingly, when painting display is performed and there is any blank area AE, the user can easily recognize that there is an area which is not imaged on the farm field 210. Then, the user can also appropriately determine, for example, whether or not to cause the flying object 200 to fly again and to capture an image. Incidentally, when there is a blank area AE, information for recommending that the blank area AE will be imaged again by re-flying of the flying object 200 can be presented. When a blank area is an area which is not necessary for generation a mapping image 91, the user can accurately determine that the mapping process is to be performed without performing flying and imaging again.

For example, when a normal display state illustrated in FIG. 2 is, for example, currently, set at the time point of Step S241 of FIG. 14, the CPU 51 sets painting to be turned on in Step S243. Then, as indicated by “D1,” the process flow progresses to the tail of FIG. 15 and the CPU 51 ends the area selection-related process (S104). In this case, in Step S102 of FIG. 12 subsequent thereto. the CPU 51 performs control such that painting display is performed on the area selection image 81. Accordingly, the area selection image 81 is subjected to painting display as illustrated in FIG. 20.

When it is determined in Step S241 of FIG. 14 that painting display is currently performed on the area selection image 81, the CPU 51 sets painting to be turned off in Step S242. Then, as indicated by “D1,” the process flow progresses to the tail of FIG. 15 and the CPU 51 ends the area selection-related process (S104). In this case, in Step S102 of FIG. 12 subsequent thereto, the CPU 51 performs control such that painting display on the area selection image 81 ends. Accordingly, the area selection image 81 is returned from painting display illustrated in FIG. 20 to, for example, normal display illustrated in FIG. 2.

By performing the above-mentioned control, the user can turn on/off painting display on the area selection image 81 using the painting button 85.

Note that painting may be performed on the frames W of all the images, may be performed on all the frames W which are selected as working areas at that time, or may be performed on the frames W of a specific range which is designated by the user.

With the painting display, the user can easily ascertain a range which is covered by the captured image.

When the process flow progresses to Step S104 of FIG. 12 by performing an area designating operation, the process flow progresses from Step S205 to Step S251 of FIG. 14 and the CPU 51 sets the imaging point PT and the frame W of the designated area to be highlighted.

Here, the area designating operation refers to an operation of designating one area on the area selection image 81 by a clicking operation with a mouse, a touch operation, a keyboard operation, or the like, which is performed by a user. Examples thereof include an operation of clicking an imaging point PT and an operation of clicking the inside of a frame W.

In the case of this clicking operation with a mouse or the touch operation, for example, a coordinate point designated by the touch operation or the like is compared with a range of an area (spatial coordinates) and an area in which the coordinate point is included in the range is detected to be designated.

Incidentally, a cursor may be sequentially located in an area with a key operation and the area in which the cursor is located at that time may be designated by a designation operation.

Then, the CPU 51 ascertains whether or not the designated area is already set to an excluded area in Step S252. Detection of whether or not each area is set to an excluded area can be performed by checking the status of the corresponding selection flag Fsel.

When the designated area is set to an excluded area, the CPU 51 sets an additional pop-up to be displayed in Step S253.

On the other hand, when the designated area is set to a working area, the CPU 51 sets an exclusive pop-up to be displayed in Step S254.

In any case, as indicated by “D1,” the process flow progresses to the tail of FIG. 15 and the CPU 51 ends the area selection-related process (S104).

In this case, in Step S102 of FIG. 12 subsequent thereto, the CPU 51 performs highlighted display of the designated area and displays a pop-up indicating an operation menu for the area.

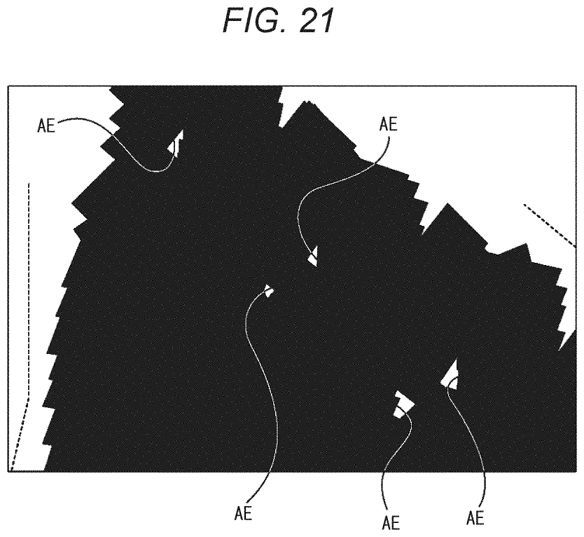

When an area set to a working area is designated and Step S254 has been performed thereon, the CPU 51 displays an exclusive pop-up illustrated in FIG. 22.

For example, display is performed such that the area (the frame W or the imaging point PT) designated by the user is marked and then one item of the following items can be designated as a pop-up menu PM for the area:

exclude this area;

exclude areas before this area; and

exclude areas after this area.

The CPU 51 provides a user with a device that designates one or more areas as excluded areas using such a pop-up menu PM.

Incidentally, an “X” button for closing the pop-up menu PM is provided in the pop-up menu PM. The same is similar to pop-up menus PM which will be described below.

Further, when an area set to an excluded area is designated and Step S253 has been performed thereon, the CPU 51 displays an additional pop-up illustrated in FIG. 22.

For example, display is performed such that the excluded area (the frame Wj or the imaging point PTj) designated by the user is marked and then one item of the following items can be designated as a pop-up menu PM for the area:

add this area;

add areas before this area; and

add areas after this area.

The CPU 51 provides a user with a device that designates one or more areas as working areas using such a pop-up menu PM.

By performing the above-mentioned control, the user can designate one area and perform various instructions with the area as a start point. The operation of the pop-up menu PM will be described later.

When the process flow progresses to Step S104 of FIG. 12 by performing a range designating operation, the process flow progresses from Step S206 to Step S261 of FIG. 14 and the CPU 51 sets the imaging points PT and the frames W of areas included in the designated range to be highlighted.

The range designating operation refers to an operation of designating a range including a plurality of areas on the area selection image 81 by a clicking operation with a mouse, a touch operation, or the like which is performed by a user.

A coordinate range corresponding to the designated range is compared with coordinate values of the imaging point PT of each area, and whether an area corresponds to the designated range can be determined depending on whether or not the coordinates of the imaging point PT is included in the designated range.

Then, the CPU 51 ascertains whether or not the areas in the designated range are already set to excluded areas in Step S262.

Incidentally, some of the plurality of areas in the designated range may be excluded areas and some thereof may be working areas. Therefore, in this case, determination may be performed depending on which of the excluded areas and the working areas is more or which of the excluded areas and the working areas is an area closest to a start point or an end point of the range designation.

When the areas corresponding to the designated range are set to excluded areas, the CPU 51 sets an additional pop-up to be displayed in Step S263.

On the other hand, when the areas corresponding to the designated range are set to working areas, the CPU 51 sets an exclusive pop-up to be displayed in Step S264. Then, in any case, as indicated by “D1,” the process flow progresses to the tail of FIG. 15 and the CPU 51 ends the area selection-related process (S104).

In this case, in Step S102 of FIG. 12 subsequent thereto, the CPU 51 performs highlighted display of the areas in the designated range and displays a pop-up indicating an operation menu for the areas.

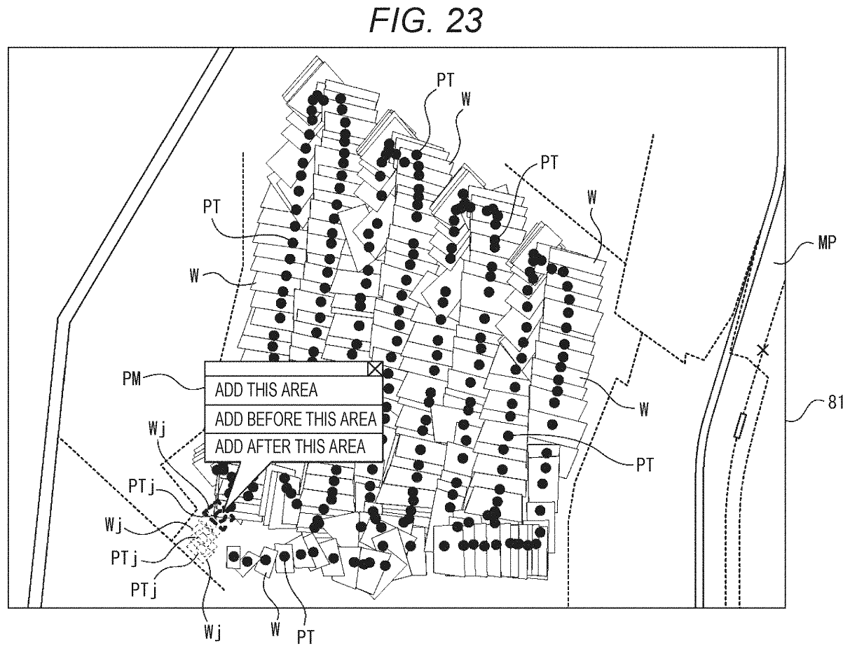

When a range of working areas is designated and Step S264 has been performed thereon, the CPU 51 displays an exclusive pop-up illustrated in FIG. 24.

For example display is performed such that the range DA designated by the user is marked and then the following operation can be instructed as a pop-up menu PM:

exclude areas in this range.

Further, when a range of excluded areas is designated and Step S263 has been performed thereon, the CPU 51 displays an additional pop-up. Although not illustrated, for example, display is performed such that the range designated by the user is marked and then the following operation can be instructed as a pop-up menu PM:

add areas in this range.

The CPU 51 provides a user with a device that designates one or more areas as excluded areas or working areas by designating a range using such a pop-up menu PM.

Incidentally, when a range is designated, a pop-up menu PM for range designation may be displayed regardless of whether areas included in the designated range are excluded areas or working areas.

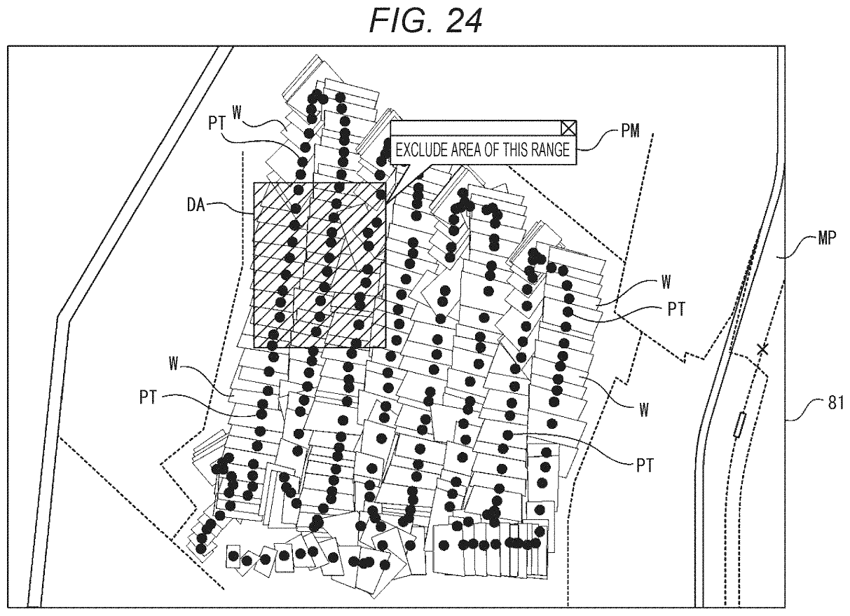

For example, as illustrated in FIG. 25, one of the following operations can be instructed as a pop-up menu PM for the designated range DA:

exclude areas in this range; and

add areas in this range.

Accordingly, an inclusive device that designates a range can be presented to the user.

In this case, when all the areas included in the designated range are excluded areas, the operation of “excluding the areas in this range” may be set to be inactive (non-selectable). Further, when all the areas included in the designated range are working areas, the item of “adding the areas in this range” may be set to be inactive.

By performing the above-mentioned control, the user can designate a certain range and issue various instructions associated with the areas included in the range.

When the process flow progresses to Step S104 of FIG. 12 by an operation during a start/end operation which is started by operating the start/end button 86, the process flow progresses from Step S207 to Step S271 of FIG. 15 and the CPU 51 ascertains whether or not the currently detected operation is an operation of the start/end button 86.

For example, after having operated the start/end button 86, the user designates an area serving as a start (a start point) and then performs an operation of designating an area serving as an end (an end point) on the area selection image 81. Accordingly, until an area is designated, the user's operation is performed in three steps of an operation of the start/end button 86, a start designation operation, and an end designation operation.

In the step in which the start/end button 86 is first operated, the process flow progresses from Step S271 to Step S272 and the CPU 51 sets the start/end operation. This is a setting operation for presenting the start/end operation to the user.

Then, as indicated by “D1,” the process flow progresses to the tail of FIG. 15, and the CPU 51 ends the area selection-related process (S104). In Step S102 of FIG. 12 subsequent thereto, the CPU 51 presents the start/end operation and performs display control such that the user is requested to designate a start point. For example, a message such as “please, designate a start point” is displayed on the area selection image 81.

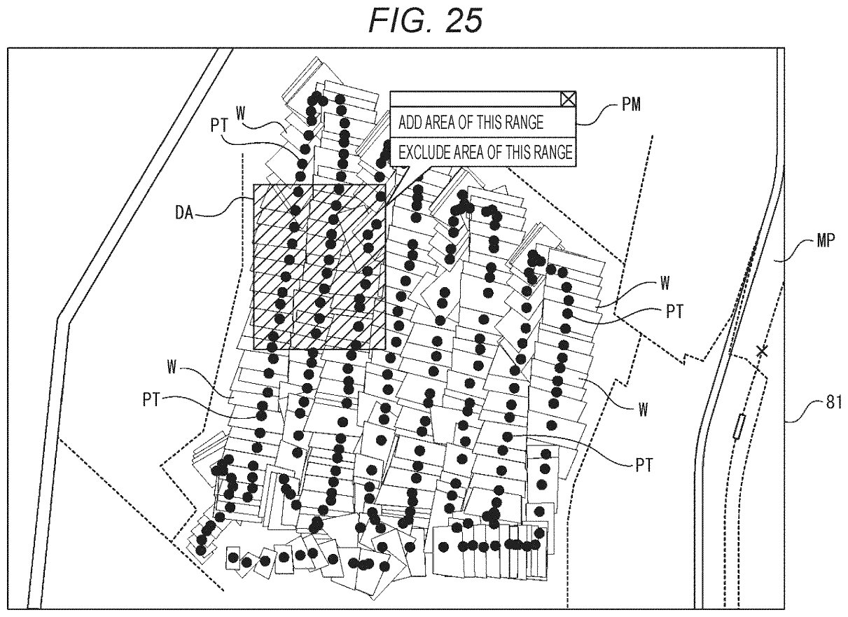

Accordingly, the user designates a start point. For example, the user performs an operation of designating an arbitrary area. In this case, the process flow progresses through Steps S207→S271→S273 and the CPU 51 performs Step S274 because it is a start designating operation. In this case, the CPU 51 sets a start area to be highlighted. Then, as indicated by “D1,” the process flow progresses to the tail of FIG. 15 and the CPU 51 ends the area selection-related process (S104). In Step S102 of FIG. 12 subsequent thereto, the CPU 51 performs control for highlighting the area designated as a start point. For example, as illustrated in FIG. 26, the frame W of the area designated by the user is emphasized and is clearly displayed as a start areas by start display STD. Further, in order to request the user to designate an end point, a message MS such as “please, designate an end point” is displayed as illustrated in the drawing.

Accordingly, the user designates an end point. For example, the user performs an operation of designating an arbitrary area. In this case, the process flow progresses through Steps S207→S271→S273 and the CPU 51 performs Step S275 because it is an end designating operation. In this case, the CPU 51 sets the start area to the end area to be highlighted and clearly set the start point and the end point. Furthermore, in Step S275, a pop-up for start/end designation is set to be displayed. Then, as indicated by “D1,” the process flow progresses to the tail of FIG. 15 and the CPU 51 ends the area selection-related process (S104) . In Step S102 of FIG. 12 subsequent thereto, the CPU 51 performs display control based on highlighting display, clear setting, and pop-up setting.

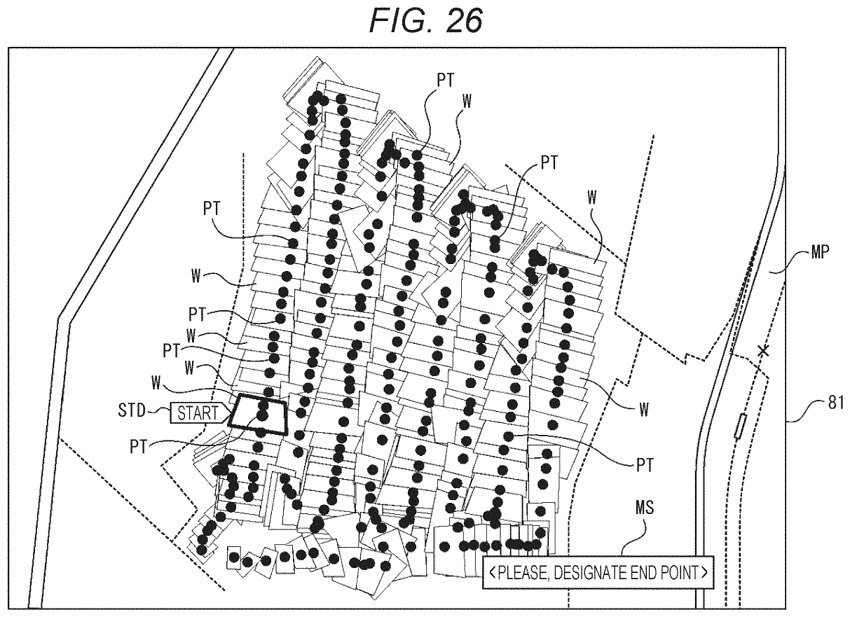

For example, as illustrated in FIG. 27, the frames W or the imaging points PT of the areas from the start point to the end point which are designated by the user are emphasized. Further, the start area and the end area are clearly displayed by start display STD and end display ED. Further, a pop-up for start/end designation is displayed.

For example, as illustrated in the drawing, one of the following operations can be instructed as a pop-up menu PM for start/end designation:

exclude areas in this range; and

add areas in this range.

As a result, a device that sets all areas in a range of arbitrary start/end points to excluded areas or working areas can be presented to the user.

Incidentally, in this case, when all the areas included in the range designated by start/end designation are excluded areas, the operation of “excluding the areas in this range” may be set to be inactive. Further, when all the areas included in the range designated by start/end designation are working areas, the item of “adding the areas in this range” may be set to be inactive.

Farther, when all or a plurality of areas of the areas included in the range designated by start/end designation or a representative area such as a start area or an end area is an excluded area, only the operation of “adding the areas in this range” may be displayed.

Similarly, when all or a plurality of areas of the areas included in the range designated by start/end designation or a representative area such as a start area or an end area is a working area, only the operation of “excluding the areas in this range” may be displayed.

By performing the above-mentioned control, the user can designate areas serving as a start point and an end point and issue various instructions associated with the areas included in the range thereof.

When the process flow progresses to Step S104 of FIG. 12 by an operation of the condition selection execution button 88, the process flow progresses from Step S208 to Step S281 of FIG. 15 and the CPU 51 determines an area corresponding to a condition.

The condition is a condition which is set by operating the condition setting unit 87.

The processing of the CPU 51 in associated with the operation of the condition setting unit 87 is not illustrated nor described in the flowchart, but the user can designate one or more conditions of conditions such as a condition of a height, a condition of change in height, a condition of a tilt, a condition of change in tilt, and a thinning condition by pull-down selection or direct input. The condition selection execution button 88 is operated at a time point at which a desired condition is input.

Accordingly, the condition for allowing the CPU 51 to perform determination in Step 3281 is a condition which is designated by the user by an operation of the condition setting unit 87 at that time.

The CPU 51 determines an image (an area) matching the condition with reference to additional information such as sensor data correlated with each image.

In Step S282, the CPU 51 sets the area corresponding to the condition to be highlighted. In addition, in Step S283, the CPU 51 sets a pop-up for condition designation to be displayed.

Then, as indicated by “D1,” the process flow progresses to the tail of FIG. 15 and the CPU 51 ends the area selection-related process (S104) . In Step S102 of FIG. 12 subsequent thereto, the CPU 51 performs display control such that the display unit 56 performs highlighting display of the area corresponding to the condition or display of a pop-up.

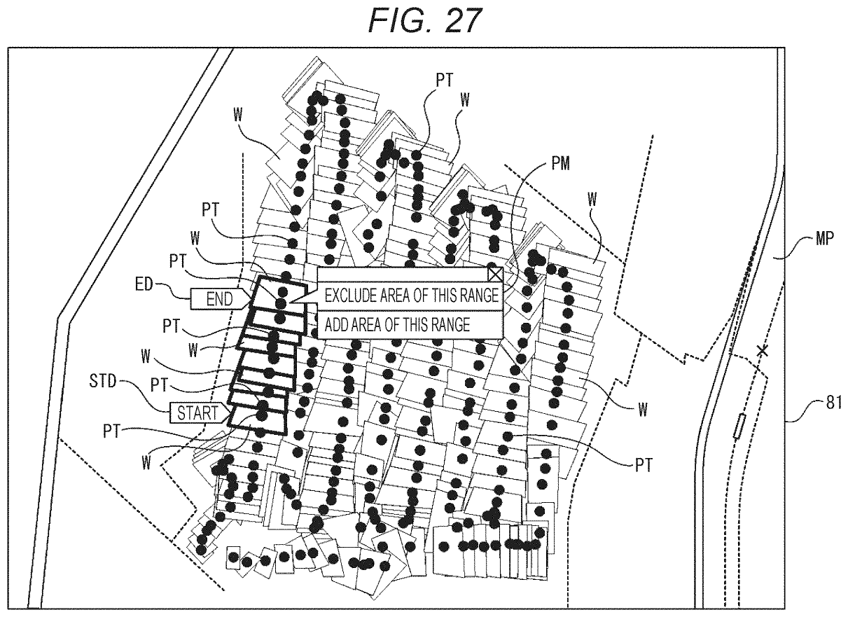

FIG. 28 illustrates a display example when a thinning condition is set. For example, when a condition of an even-numbered area is designated, the frames W or the imaging points PT of even-numbered areas are displayed to be emphasized. Then, a pop-up menu PM is displayed as an operation associated with a condition-satisfying area and, for example, the following operations can be instructed:

exclude the corresponding area; and

add the corresponding area.

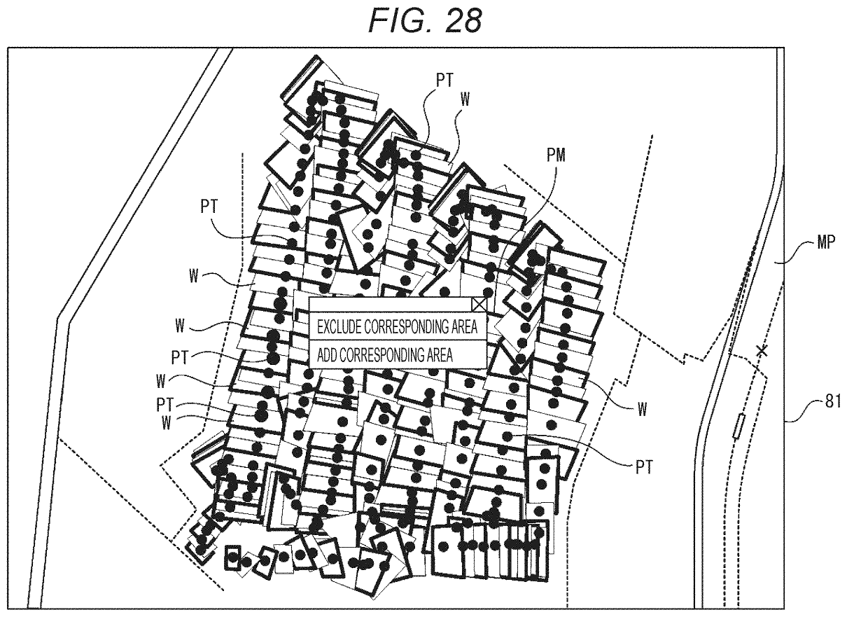

FIG. 29 illustrates a display example when a condition of a height or the like is set, where the frames W or the imaging points PT of the areas corresponding to the condition are displayed to be emphasized. Then, similarly, a pop-up menu PM is displayed as an operation associated with a condition-satisfying area.

Incidentally, in this case, when all the areas corresponding to the condition are excluded areas, the operation of “excluding the areas in this range” may be set to be inactive. Further, when all the areas corresponding to the condition are working areas, the item of “adding the areas in this range” may be set to be inactive. FIG. 29 illustrates a state in which the operation of “adding the areas in this range” is set to be inactive.

Further, when all or a plurality of areas of the areas corresponding to a condition or a representative area thereof is an excluded area, only the operation of “adding the areas in this range” may be displayed. When ail or a plurality of areas of the areas corresponding to the condition or a representative area thereof is a working area, only the operation of “excluding the areas in this range” may be displayed.

By performing the above-mentioned control, the user can designate an arbitrary condition and issue various instructions associated with an area satisfying the condition.

Incidentally, the condition which can be designated by a user, that is, the condition for allowing the CPU 51 to determine the condition-satisfying area in Step S281, may be a single condition or combination of a plurality of conditions. Further, when the number of conditions is two or greater, an AND condition, an OR condition, or a NOT condition may be designated.

For example, designation of “a height of 30 m or greater” AND “a tilt less than 10°” or designation of “small change in height” OR “even-numbered” may be possible.

A case where a pop-up menu PM is displayed has been described above, and an operation may be performed on the pop-up menu PM.

When the process flow progresses to Step S104 of FIG. 12 by detecting an operation on the pop-up menu PM, the CPU 51 performs Step S209 to Step S291 of FIG. 15. When the operation is an operation of closing the pop-up menu PM (for example, an operation of the “X” button), the process flow progresses from Step S291 to Step S295 and the CPU 51 sets the pop-up menu PM to be non-displayed. In this case, as indicated by “D1,” the CPU 51 ends the area selection-related process (S104). In Step S102 of FIG. 12 subsequent thereto, the CPU 51 ends display of the pop-up. Incidentally, in this case, the operation for displaying the pop-up menu PM may be cancelled and highlighting display of the designated area may be ended.

In the above-mentioned pop-up menu PM, there is likelihood that an item of the operation of excluding an area and an item of the operation of adding an area will be designated. In Step S292, the CPU 51 divides the process flow depending on whether the item of the operation of excluding an area is designated or the item of the operation of adding an area is designated.

When the item of the operation of excluding an area is designated, the process flow progresses in the order of Steps S209→S291→S292→S293→S294 and the CPU 51 sets the target area of the designated item to be excluded.

For example, when the item of “excluding this area” is designated in the pop-up menu PM illustrated in FIG. 22, the CPU 51 sets the selection flag of the designated area to Fsel=1.

Further, when the item of “excluding areas before this area” is designated, the CPU 51 sets the selection flags of all the areas from the designated area to the first area in a time series to Fsel=1.

Further, when the item of “excluding areas after this area” is designated, the CPU 51 sets the selection flags of all the areas from the designated area to the last area in a time series to Fsel=1.

Then, as indicated by “D1,” the process flow transitions to the tail of FIG. 15 and the CPU 51 ends the area selection-related process (S104). In Step S102 of FIG. 12 subsequent thereto, the CPU 51 ends display of the pop-up and performs control for performing display in which the setting for exclusion is reflected.

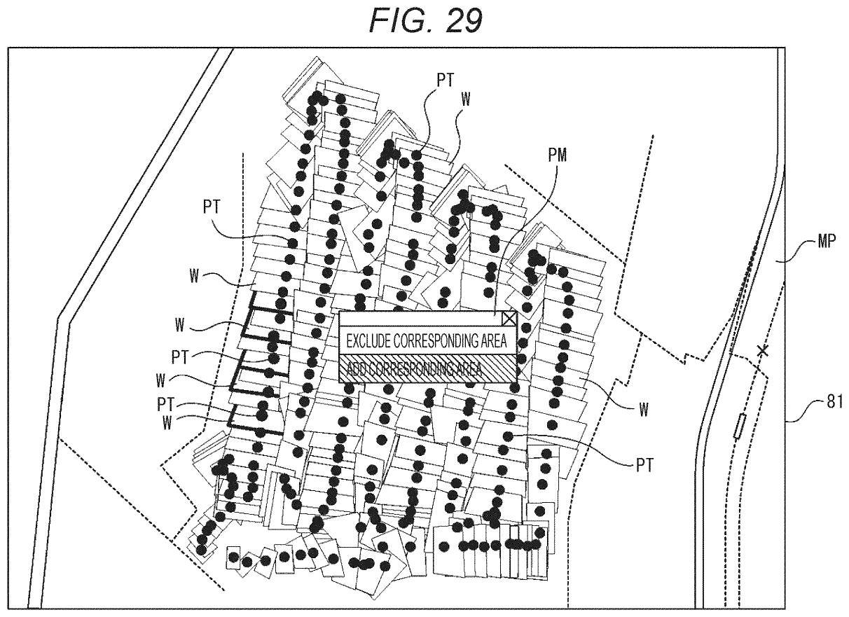

For example, it is assumed that the area selection image 81 before being operated is in the state illustrated in FIG. 30.

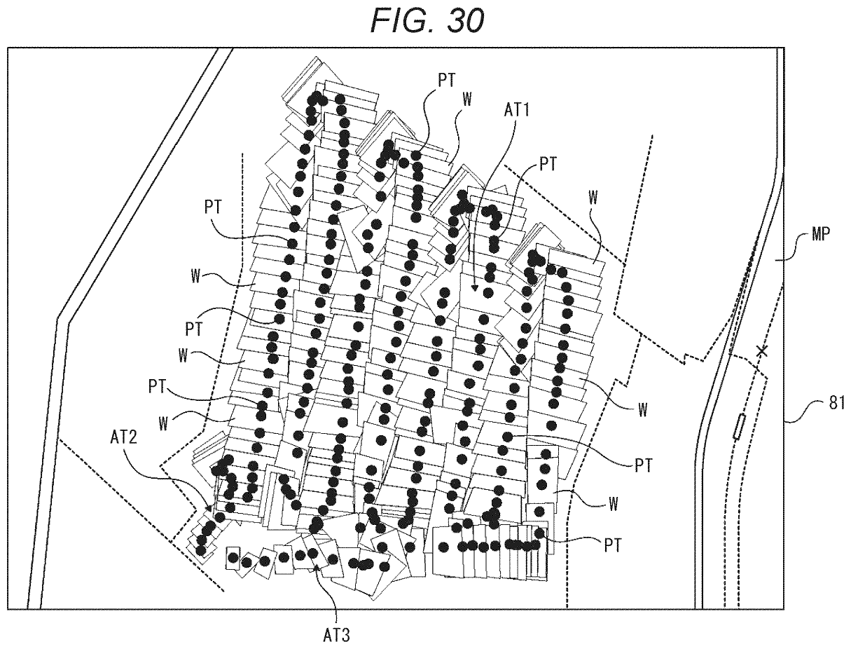

Here, it is assumed that an operation of designating an area indicated by an arrow AT1 is performed and highlighting of designated areas and display of a pop-up menu PM are performed as illustrated in FIG. 22. When the item of “excluding this area” is designated in this state, the frame Wj or the imaging point PTj of the corresponding area in the area selection image 81 which is displayed is displayed, as illustrated in FIG. 31, such that it is displayed the corresponding area is set to an excluded area. Alternatively, display thereof is deleted.

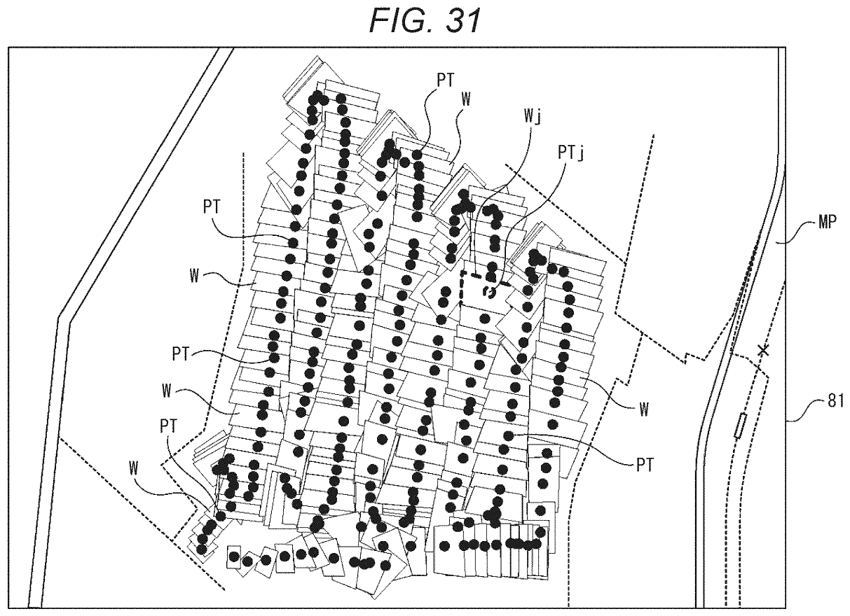

Further, when an operation of designating an area indicated by an arrow AT2 in FIG. 30 is performed and the item of “excluding areas before this area” is designated in the state in which the pop-up menu PM illustrated in FIG. 22 is displayed, the frames Wj or the imaging points PTj indicating that all the areas from the designated area to the first area in a time series are excluded areas are displayed (or deleted) as illustrated in FIG. 32.

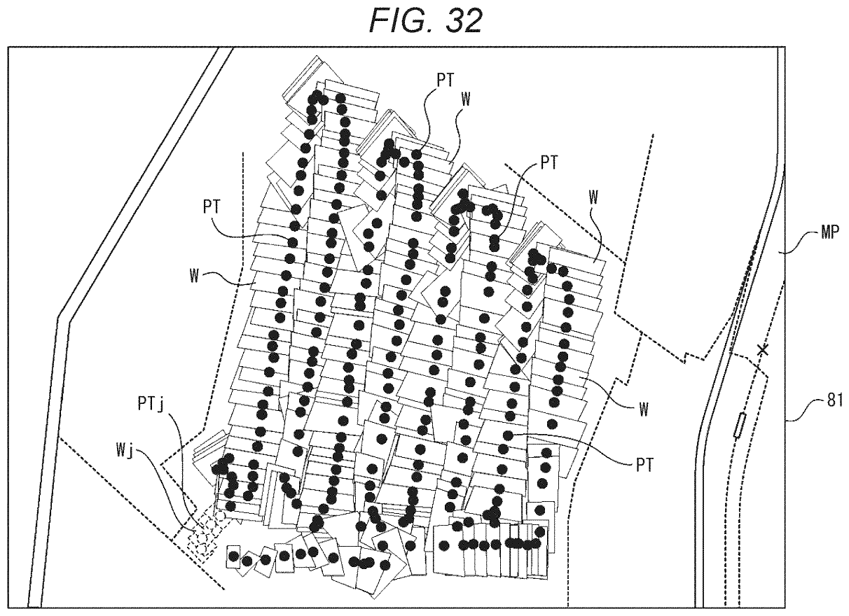

Further, when an area indicated by an arrow AT3 in FIG. 30 is designated, the pop-up menu PM is displayed, and the item of “excluding areas after this area” is designated, the frames Wj or the imaging points PTj indicating that all the areas from the designated area to the last area in a time series are excluded areas are displayed (or deleted) as illustrated in FIG. 33.

The setting of the selection flags Fsel or the display change for presenting the excluded areas is performed on the corresponding areas similarly when the item of the operation of excluding an area in FIGS. 24, 25, 27, 28, and 29 is designated.

When the item of the operation of adding an area is designated as an operation of the pop-up menu PM, the process flow progresses in the order of Steps S209→S291→S292→S293 in FIG. 15 and the CPU 51 sets the target area of the designated item t.o be added.

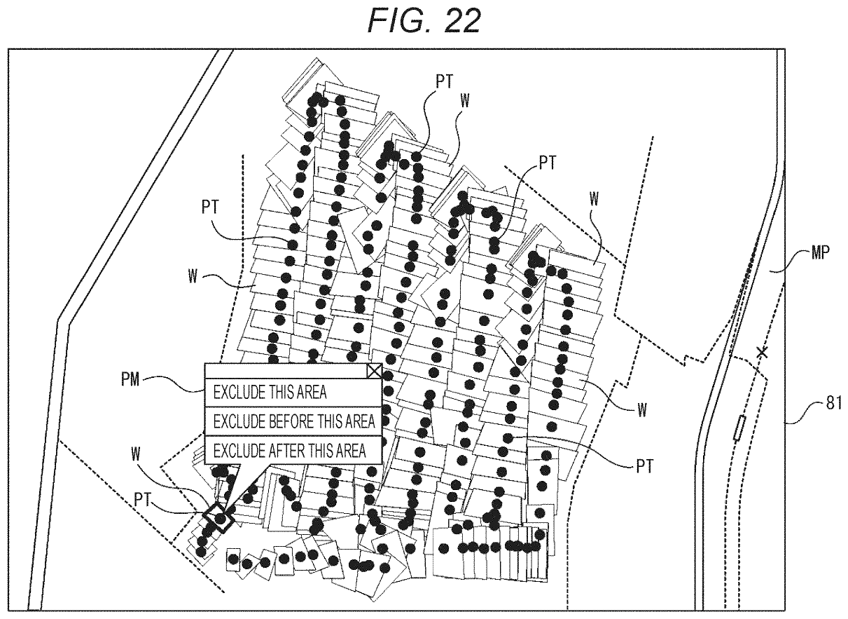

For example, when the item of “adding this area” is designated in the pop-up menu PM illustrated in FIG. 23, the CPU 51 sets the selection flag of the designated area to Fsel=0.

Further, when the item of “adding areas before this area” is designated, the CPU 51 sets the selection flags of all the areas from the designated area to the first area in a time series to Fsel=0.

Further, when the item of “adding areas after this area” is designated, the CPU 51 sets the selection flags of all the areas from the designated area to the last area in a time series to Fsel=0.

Then, as indicated by “D1,” the CPU 51 ends the area selection-related process (S104). In Step S102 of FIG. 12 subsequent thereto, the CPU 51 ends display of the pop-up and performs control for performing display in which the setting for addition is reflected.

In this case, the frames Wj or the imaging points PTj which are displayed to be non-conspicuous such as translucent (or deleted) are displayed by normal frames W or imaging points PT.

The setting of the selection flags Fsel or the display change for presenting the working areas is performed on the corresponding areas similarly when the item of the operation of adding an area in FIGS. 25, 27, and 28 is designated.

By performing the above-mentioned control on an operation of the pop-up menu PM, the user can perform the operations which are provided as types of items displayed in the pop-up menu PM.

While examples of the area selection-related process of Step S104 of FIG. 12 have been described above with reference to FIGS. 13, 14, and 15, these are only examples and various examples can be considered as the display change of the area selection image 81 or the process associated with selection of areas which are used for the mapping process.

In the process flows illustrated in FIGS. 13, 14, and 15, by performing ON/OFF of display of an imaging point PT, ON/OFF of display of a frame W, ON/OFF of display of an excluded area, and ON/OFF of painted display, a user can easily ascertain a range of captured images, an overlap state of each image, a range which is covered by working areas, and the like, which are considerable information for the user to determine whether to perform work. Further, by properly using designation of an area, designation of a range, designation of start/end points, designation of a condition, and an operation on a pop-up menu PM, a user can efficiently select an image (an area) which is useful for a mapping process. Accordingly, it is possible to appropriately prepare for performing a mapping process with high quality with a small processing load and to efficiently perform the preparation.

Incidentally, in the above-mentioned examples, an area which is designated by a user's operation is set to an excluded area (an excluded image) or a working area (a working image), but an area other than the area which is designated by a user's operation may be set to an excluded area (an excluded image) or a working area (a working image).

### 4. Second Embodiment

A processing example of a second embodiment will be described below. This example is a processing example which can be employed instead of the process flow illustrated in FIG. 12 in the first embodiment. Note that the same processes as m FIG. 12 will be referred to by the same step numbers and detailed description thereof will not be repeated.

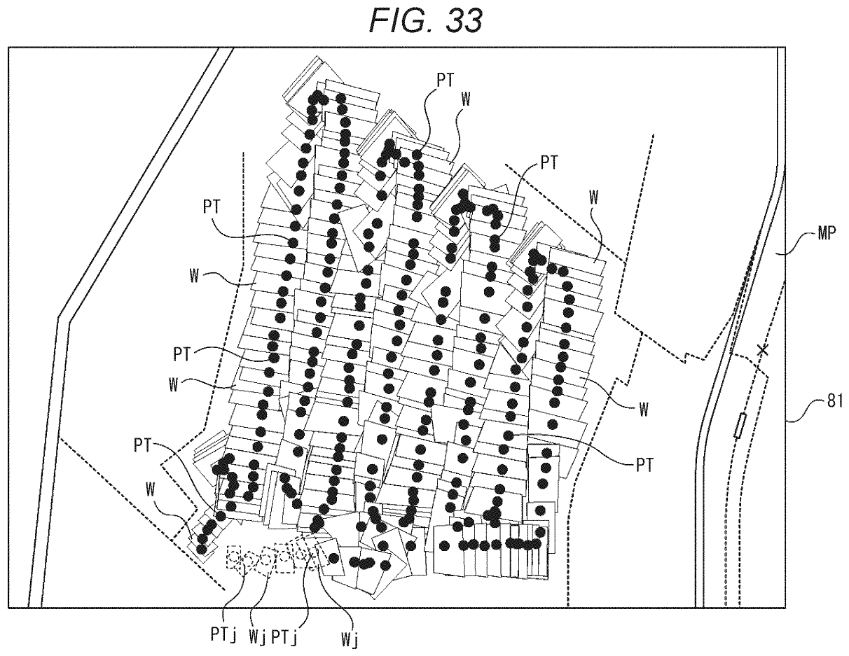

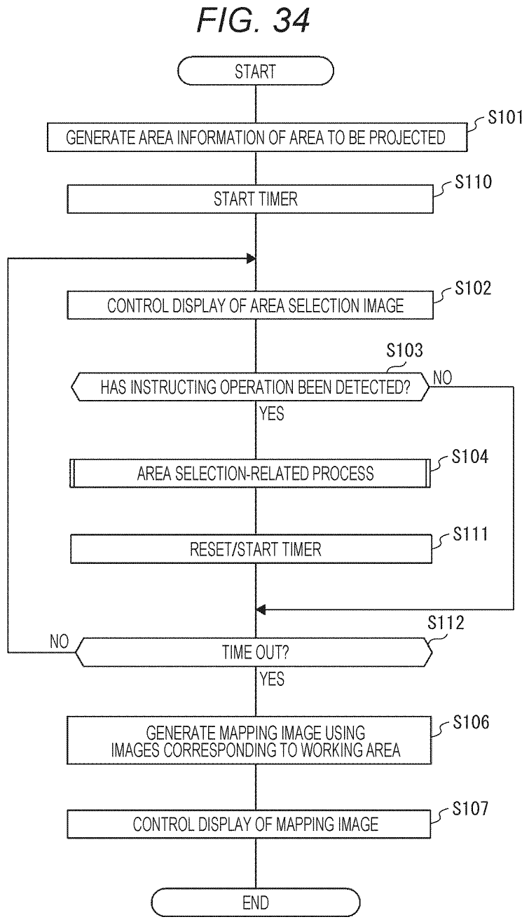

In Step S101 of FIG. 34, the CPU 51 generates area information of areas to which captured images are projected. Then, in Step S110, the CPU 51 starts counting of a timer for timeout determination.

In Step S102, the CPU 51 performs control for displaying an area selection interface image 80 (see FIG. 2) including an area selection image 81 on the display unit 56.

In the period in which the area selection interface image 80 is displayed, the CPU 51 monitors a user's operation in Step S103.

Further, in Step S112, the CPU 51 determines whether or not the timer times out. That is, the CPU 51 ascertains whether or not the count of the timer reaches a predetermined value.

When an instruction operation is detected in Step S103, the CPU 51 performs an area selection-related process (for example, the process flow in FIGS. 13, 14, and 15) in Step S104.

Then, in Step Sill, the timer for determination of timeout is reset and counting of the timer is restarted. That is, the timer is reset by performing a certain instruction operation.

Further, when a predetermined time elapses without performing an instruction operation in a state in which the area selection interface image 80 is displayed, it is determined that the timer times out in Step S112.

When the timer times out, the CPU 51 performs a process of generating a mapping image 91 using images (selected images) which are selected as working areas at that time in Step S106.

Then, the CPU 51 performs display control of the mapping image 91 in Step SI0'7. That is, the CPU 51 performs a process of displaying a vegetation observation image 90 (see FIG. 3) on the display unit 56.

That is, the process example illustrated in FIG. 34 is an example in which a user's operation for transitioning to the mapping process is not particularly necessary and the mapping process is automatically started by timeout. The mapping process is a process requiring a relatively long time. Accordingly, by starting the mapping process when a user's operation is not performed, it is possible to perform mapping while effectively using a user's time.

### 5. Third Embodiment

A third embodiment will be described below.

In the above description, a user can select an appropriate image which is used for a mapping process while watching the frames W or the like indicating areas corresponding to a series of images for the mapping process, but a function of supporting the user's operation may be provided.

For example, the area information generating unit 11 illustrated in FIG. 6 may have a function of generating information which is recommended for a user.

In this case, the area information generating unit 11 generates area information indicating an area for the purpose of supporting a user's operation. For example, the area information generating unit 11 generates area information indicating areas to be recommended. For example, the area information generating unit 11 determines whether each area satisfies a predetermined condition, selects areas satisfying the predetermined condition as candidates for “unnecessary areas,” and instructs the image generating unit 14 to display the candidates.

The following criteria and the like can be considered as a criterion for “unnecessary” mentioned herein:

an area in which an overlap area with a neighboring rectangle (a frame W) is equal to or greater than a predetermined value;

an area in which the size/distortion of the rectangle (a frame W) is equal to or greater than a predetermined value;

an area in which continuity of rectangular patterns departs from a predetermined range;

an area which is learned on the basis of previous user-designated areas; and

an area which is designated on the basis of an allowable data range.

Incidentally, the area information generating unit 11 can also select the candidates for “unnecessary area” on the basis of additional data (position information, height information, and the like) correlated with each image.

In areas in which an overlap area between neighboring rectangles (frames W) is equal to or greater than a predetermined value (for example, images of which image ranges are almost the same), the overlap area between images is large, efficiency of a mapping process decreases, and one thereof can be considered to be unnecessary. Therefore, the frames W of the unnecessary areas are presented to a user as the candidates for areas which are excluded from use in the mapping process.

In areas in which the size/distortion of the rectangle (the frame W) is equal to or greater than a predetermined value, a processing load of a correction calculation operation increases at the time of the mapping process (for example, stitch) or there is likely to be difficulty in matching neighboring images. Therefore, when there is no problem in excluding such areas, the areas are set as unnecessary areas and the frames W may be presented to a user as the candidates for areas which are excluded from use in the mapping process.

Incidentally, the area information generating unit 11 can determine whether an alternative image is further present around an area satisfying the predetermined condition (an image including the area) and select the area as a candidate for “unnecessary area” when it is determined that an alternative image is present.

In an area in which continuity of rectangular patterns departs from a predetermined range, there is likelihood that the mapping process may not be appropriately performed. Therefore, this area is determined as an unnecessary area and the frame W thereof may be presented to a user as the candidate for an area which is excluded from use in the mapping process.

Specifically, when a distance along which an imaging position departs from a flying route which is designated in a flight plan is outside a predetermined range, an area of an image which is acquired at the imaging position can also be selected as a candidate for an “unnecessary area.”

An area which is learned on the basis of previous user-designated areas is, for example, an area which is designated as an excluded area a plurality of times by a user. For example, when a user excludes a first area of a series of images every tine as illustrated in FIG. 32, the area is presented as an exclusion candidate in advance.

In an area which is designated on the basis of an allowable data range, for example, an upper limit of the number of images which are used is set, for example, depending on a capacity load or a calculation load for the mapping process, and a predetermined number of areas are presented as the candidates for “unnecessary areas” such that the predetermined number do not exceed the upper limit.

For example, images (areas) can be regularly thinned out from a plurality of images which are continuous in a time series and the other area3 can also be selected as the candidates for “unnecessary areas.” The thinning rate can also be changed on the basis of the allowable data range.

When the candidates for areas which are excluded from use for the mapping process are presented in this way, the area selecting unit 12 can exclude such areas from use for the mapping process in response to a user's permission operation which is detected by the detection unit 13.

Alternatively, the area selecting unit 12 may automatically exclude such areas regardless of a user's operation.

Incidentally, regarding display of the candidates extracted as unnecessary areas, a color in which the frame W or the imaging point PT thereof is displayed or a color inside the frame W may be changed or emphasized.

By performing this process of supporting an operation, it is possible to usefully reduce an amount of data in a mapping process and to improve easiness of a user's understanding.

Incidentally, regarding recommendation, for example, when a mapping process is affected due to exclusion of an area which a user intends to exclude, for example, when a blank area AE described above with reference to FIG. 21 is formed, an influence of the exclusion may be presented and non-exclusion thereof may be recommended.

In addition to the above-mentioned operation support or instead of the above-mentioned operation support, the area selecting unit 12 may select a quantity of areas which are used for mapping on the basis of an allowable amount of data in the information processing apparatus 1. For example, when an area designated by a user is detected by the detection unit 13, the area selecting unit 12 selects at least some areas of a plurality of areas as target areas of the mapping process on the basis of the area detected by the detection unit 13.

That is, without setting all the areas designated by a user as a target of the mapping process, the area selecting unit 12 sets some thereof as a target of the mapping process such that an appropriate amount of data is maintained.

Accordingly, it is possible to reduce an amount of data and to reduce a system load.

Further, by combining the determinations of “unnecessary areas,” determining unnecessary areas from areas designated by a user, and excluding the unnecessary areas from use for the mapping process, it is possible to generate an appropriate mapping image with a small capacity.

### 6. Conclusion and Modified Examples

The following advantageous effects are obtained from the above-mentioned embodiments.

The information processing apparatus 1 according to the embodiments includes the area information generating unit 11 that generates area information indicating each area of a plurality of images which are projected to a projection surface, the detection unit 13 that detects an area which is designated by a user operation out of the plurality of areas presented on the basis of the area information, and the area selecting unit 12 that selects at least some areas of the plurality of areas on the basis of the area detected by the detection unit 13.

That is, in the above-mentioned embodiments, for example, a plurality of images which are arranged in a time series by continuously capturing an image while moving are projected to, for example, a plane which is a projection surface according to the imaging positions, respectively. In this case, area information indicating an area which is projected to the projection surface is generated for each captured image, and a user can perform an operation of designating each area indicated on an area selection image 81 on the basis of the area information. Then, some areas which are subjected to the designation operation are selected as areas which are used for a next process or which are not used in response to the operation.

Particularly, in the above-mentioned embodiments, a mapping image indicating vegetation is generated in a next process, and areas which are used to generate the mapping image are selected. That is, a plurality of areas to which each of the images is projected are presented to a user and areas which are used for mapping are selected from the plurality of areas on the basis of the areas designated by the user.

For example, areas designated by the user operation are excluded from areas which are used for mapping.

Alternatively, the areas designated by the user operation may be set to areas which are used for mapping.

In any case, accordingly, it is possible to perform mapping using images of some selected areas instead of using all the areas (images) of the captured images and thus to reduce a process load for a mapping image generating process.

Particularly, it takes much time to perform an image mapping process using many captured images and reduction of the process load thereof is useful for shortening the time until a mapping image is presented and an increase in efficiency of a system operation.

Furthermore, by ascertaining projected positions of each of the images through display of the area selection image 81 before the mapping process, a user can determine whether to perform the mapping image generating process (determine whether an instruction to start generation of a mapping image, which is detected in Step SI05 of FIG. 12, is suitable) and accurately determine, for example, retrying the imaging using the flying object 200 or the like. Further, it is also possible to prevent occurrence of a failure after the mapping process.

Further, accordingly, it is possible to reduce the labor and the time loss in retrying the mapping process or the imaging and thus to achieve a decrease in power consumption of the information processing apparatus 1, a decrease in work time, a decrease in data volume, and the like. As a result, it is possible to achieve a decrease in the number of components mounted in the flying object 200, a decrease in weight, a decrease in costs, and the like.

Further, in the embodiments, the plurality of images which are subjected to the mapping process are a plurality of images which are captured at different times and arranged in a time series. For example, the plurality of images are images which are acquired by a series of imaging which is continuously performed while moving the position of the imaging device and are images which are associated to be arranged in a time series. In view of the embodiments, the plurality of images are images which are acquired by a series of imaging which is continuously performed by the imaging device 250 mounted in the flying object 200 while moving the imaging device in the period from a flight start to a flight end.

The technique described in the embodiments can increase efficiency of the operation of excluding images which are not suitable for combination by mapping on the basis of a user's intention when the mapping process is performed on the plurality of images which are associated series of images and arranged in a tine series.

As long as the plurality of images are a series of images which are to be mapped and which are associated to be arranged in a time series, the present technology can be applied to images other than the images acquired by the above-mentioned remote sensing.

In the embodiments, an example is illustrated in which the information processing apparatus 1 includes the image generating unit 15 that performs the mapping process using the images corresponding to the areas selected by the area selecting unit 12 out of the plurality of images and generates a mapping image (see FIG. 6).

Accordingly, a series of processes from selection of an area to generation of a mapping image is performed by the information processing apparatus 1 (the CPU 51). This can be realized by performing a user's operation on the area selection image and browsing the mapping image subsequent to the operation as a series of processes. In this case, repeated execution of generation of the mapping image, an area selecting operation, and the like can be facilitated by efficiently performing the process of generating the mapping image.

Particularly, in the embodiments, the mapping process is a process of associating and combining the plurality of images which are captured at different times and arranged in a time series to generate the mapping image. Accordingly, a combined image in a range in which the images are captured at different times can be acquired using the images selected by the function of the area selecting unit 12.

In the embodiment, the area selecting unit 12 performs a process of selecting areas for the mapping process on the basis of the areas which are detected by the detection unit 13 and which are individually designated by the user operation (see S205 and S251 to S254 in FIG. 14 and S209 and S291 to S294 in FIG. 15).

Accordingly, even when areas which are to be designated as the areas for the mapping process are scattered, a user can easily perform a designation operation.

In the embodiments, the area selecting unit 12 performs a process of selecting the areas which are detected by the detection unit 13 and which are individually designated by the user operation as the areas which are used for the mapping process (see S253 in FIG. 14 and S293 in FIG. 15). That is, when a user can perform an operation of directly individually designating the areas indicated by the area information, the designated areas can be selected as areas corresponding to images which are used for the mapping process.

Accordingly, when areas which are to be used for the mapping process (images corresponding to the areas) are scattered, a user can easily designate the areas. Incidentally, areas other than the areas which are directly designated by a user may be selected as areas corresponding to the images which are used for the mapping process.

In the embodiment, the area selecting unit 12 performs a process of selecting the areas which are detected by the detection unit 13 and which are individually designated by the user operation as areas which are excluded from use for the mapping process (see S254 in FIG. 14 and S294 in FIG. 15).

That is, when a user can perform an operation of directly individually designating the areas indicated by the area information, the designated areas can be selected as areas corresponding to images which are not used for the mapping process.

Accordingly, when areas which are not necessary for the mapping process (images corresponding to the areas) or areas of images which are not suitable for mapping (images in which imaging ranges do not sufficiently overlap, images in which a farm field is not correctly captured, or the like) are scattered, a user can easily designate the areas.

Incidentally, areas other than the areas which are directly designated by a user may be selected as areas corresponding to the images which are not used for the mapping process.

In the embodiments, the area selecting unit 12 performs a process of selecting areas for a mapping process on the basis of the areas which are detected by the detection unit 13 and which are designated as continuous areas by the user operation (see FIGS. 13, 14, and 15).

Accordingly, even when areas which are to be designated as the areas for the mapping process are continuous, a user can easily perform a designation operation.

In the embodiment, the area selecting unit 12 performs a process of selecting the areas for the mapping process on the basis of a designation start area and a designation end area which are detected by the detection unit 13 and which are designated by the user operation (see S207, S271 to S276, S209, and S291 to S294 in FIG. 15).

That is, by performing an operation of designating start/end points as the user operation, a plurality of areas from the start area to the end area can be designated.

Accordingly, when areas (images corresponding to the areas) which are not necessary for the mapping process are continuous, a user can easily designate the areas. Alternatively, even when areas (images corresponding to the areas) which are to be used for the mapping process are continuous, a user can easily perform the designation operation.

Incidentally, areas other than the areas which are designated by the user may be selected together as areas corresponding to the images which are not to be used for the mapping process or may be selected as areas corresponding to the images which are to be used for the mapping process.

In the embodiments, the area selecting unit 12 performs a process of selecting the areas for the mapping process on the basis of a designation end area which is detected by the detection unit 13 and which is designated by the user operation (see S205, S251 to S254, S209, and S291 to S294 in FIG. 15).

For example, regarding a designated area, an instruction to “exclude areas before this area” or to “add areas before this area” car. be issued as the user operation. Accordingly, when areas (images corresponding to the areas) which are not necessary for the mapping process or areas (images corresponding to the areas) which are to be used for the mapping process are continuous from the head of the entire areas, a user can easily designate the areas. The head area is, for example, an area corresponding to an image which is captured first out of a plurality of images which are continuously captured by the imaging device 250 mounted in the flying object 200 and which are associated as a series of images and arranged in a time series.

Specifically, for example, when the flying object 200 starts flight and a predetermined number of images after imaging has been started by the imaging device 250 are unstable images (for example, images in which the imaging directions are deviated, the heights are not sufficient, the farm field 210 is not appropriately imaged or the like), a very convenient operation can be provided when it is intended to exclude the images which are not suitable for combination from the mapping process together.

In the embodiments, the area selecting unit 12 performs a process of selecting the areas for the mapping process on the basis of a designation start area which is detected by the detection unit 13 and which is designated by the user operation (see S205 and S251 to S254 in FIG. 14 and S209 and S291 to S294 in FIG. 15).

For example, regarding a designated area, an instruction to “exclude areas after this area” or to “add areas after this area” can be issued as the user operation.

Accordingly, when areas (images corresponding to the areas) which are not necessary for the mapping process or areas (images corresponding to the areas) which are to be used for the mapping process are continuous at the end of all the areas, a user can easily designate the areas, that is, the areas from the designation start area to the final area. The final area is, for example, an area corresponding to an image which is finally captured out of a plurality of images which are continuously captured by the imaging device 250 mounted in the flying object 200 and which are associated as a series of images and arranged in a time series.

Specifically, for example, when images captured in a period after the flying object 200 ends its flight at a predetermined height and until the flying object lands are not suitable for combination and are not necessary, a very convenient operation can be provided when it is intended to exclude the images from the mapping process together.

In the embodiments, the area selecting unit 12 performs a process of selecting areas for a mapping process on the basis of areas which are detected by the detection unit 13 and which correspond to a user's condition designating operation (see S208, S281 to S283, S209, and S291 to S294 in FIG. 15).

That is, a user can designate various conditions and perform area designation as areas corresponding to the conditions.

Accordingly, when it is intended to designate areas corresponding to a specific condition as areas designated for the mapping process, a user can easily perform the designation operation.

In the embodiments, designation of an area based on a condition of a height at which the imaging device 250 is located at the time of capturing an image is able to be performed as the condition designating operation. For example, a condition of a “height of (x) m or greater,” a condition of a “height of (x) m or less,” a condition of a “height of (x) m to (y) m,” or the like can be designated as the condition for designating an area. Accordingly, when it is intended to designate areas (images corresponding to the areas) which are not necessary for the mapping process or areas (images corresponding to the areas) which are to be used for the mapping process under the condition of a specific height, a user can easily perform the designation operation. For example, when it is intended to designate only areas of images captured when the flying object 200 flies at a predetermined height, when it is intended to exclude images at the time of start of flight, when it is intended to exclude images at the time of end of flight (at the time of landing), and the like, it is possible to efficiently perform the designation operation.

Particularly, since change m imaging range, change in focal distance, change in image size of a subject due thereto, and the like are caused depending on the height. there is demand for performing the mapping process using images at a certain fixed height. It is possible to easily cope with such demand and thus to contribute to generation of a mapping image with high quality as a result.

In the embodiment, designation of an area based on a condition of change in height of a position of the imaging device 250 at the time of capturing an image is able to be performed as the condition designating operation. For example, a condition that the change in height is equal to or less than a predetermined value, a condition that the change in height is equal to or greater than a predetermined value, a condition that the change in height is in a predetermined range, and the like can be designated as the condition for designating an area.

Accordingly, when it is intended to designate areas (images corresponding to the areas) which are not necessary for the mapping process or areas (images corresponding to the areas) which are to be used for the mapping process under the condition of specific change in height, a user can easily perform the designation operation.

This configuration is suitable, for example, when it is intended to designate only areas of images captured when the flying object 200 flies stably at a predetermined height (when the height is not being changed), or the like.

In the embodiments, designation of an area based on a condition of an imaging orientation of the imaging device 250 at the time of capturing an image is able to be performed as the condition designating operation. For example, a condition that the tilt angle as the imaging orientation is equal to or less than a predetermined value, a condition that the tilt angle is equal to or greater than a predetermined value, a condition that the tilt angle is in a predetermined range, and the like can be designated as the condition for designating an area. Accordingly, when it is intended to designate areas (images corresponding to the areas) which are not necessary for the mapping process or areas (images corresponding to the areas) which are to be used for the mapping process under the condition of a specific imaging orientation, a user can easily perform the designation operation.

Particularly, the orientation of the flying object 200 (the imaging orientation of the imaging device 250 mounted in the flying object 200) varies depending an influence by wind, a flying speed, change in a flying direction, or the like and the imaging device 250 may not necessarily capture an image just below. Depending on the imaging orientation (angle) of the imaging device 250, an image in which the farm field 210 is not appropriately captured, that is, an image which is not suitable for combination, may be generated. Accordingly, for example, an area (an image) which is not to be used is capable of being designated depending on the condition of the imaging orientation becomes a very convenient function from the viewpoint in which unnecessary images are not used to generate a mapping image.

In the embodiments, the area information includes information of an outline of an area of an image which is projected to the projection surface.

For example, an area of an image which is projected as a frame W of a projection surface is displayed on the basis of the information of the outline. Accordingly, for example, an area can be clearly presented on display for a user interface and a user can perform an operation of designating an area while clearly understanding positions or ranges of each of the areas.

Incidentally, the display form indicating the outline of an area is not limited to the frame W, as long as at least a user can recognize the outline. Various display examples such as a figure having a shape including the outline, a range indicating the outline in a specific color, and a display from which the outline can be recognized as a range by hatching, pointillism, and the like can be conceived.

Furthermore, the area selection interface image 80 is not limited to a two-dimensional image, but may be a three-dimensional image, an overhead image seen from an arbitrary angle, or the like. Various forms may be used as the frame W accordingly.

Further, similarly, various display forms can also be used as the imaging point PT.

Incidentally, in the area selection image 81, the frames W may not be displayed but only the imaging points PT may be displayed. When only the imaging points are displayed, information of the imaging points PT can include only the coordinate values of points and thus it is advantageous in that it is possible to decrease an amount of information.

The information processing apparatus 1 according to the embodiments includes the display control unit 16 which is configured to perform a process of displaying area visualization information for visually displaying each of the areas of a plurality of images which are projected to a projection surface and a process of displaying at least some areas of the plurality of areas on the basis of designation of an area by a user operation on display using the area visualization information.

The area of each image which is projected to the projection surface is displayed, for example, on the basis of the area visualization information (for example, the frame W and the imaging point PT) indicating the position and the range of the area. A user can perform the designation operation on display using the area visualization information and at least some areas are displayed according to the operation.

By displaying the frame W or the imaging point PT of the projection surface as the area visualization information, a user can clearly recognize an area to which a captured image is projected and perform the designation operation. Accordingly, it is possible to improve easiness and convenience of the operation.

The information processing apparatus 1 according to the embodiments performs a process of displaying a mapping image which is generated using images corresponding to areas selected on the basis of the areas designated by the user operation.

That is, when the mapping process using images corresponding to the selected areas is performed subsequent to selection of the areas based on display of an area visualization image (for example, the frame W and the imaging point PT), display control of the mapping image 91 is also performed.

Accordingly, display control for a series of processes from selection of areas to generation of the mapping image is performed by the information processing apparatus (the CPU 51). Accordingly, a user can refer to a series of interface screens for the area designating operation to browsing of the mapping image and it is possible to achieve improvement in efficiency of a user's operation.

A program according to the embodiments causes the information processing apparatus to perform: a generation process of generating area information indicating each area of a plurality of images which are projected to a projection surface; a detection process of detecting an area which is designated by a user operation out of the plurality of areas presented on the basis of the area information; and an area selecting process of selecting at least some areas of the plurality of areas on the basis of the area detected in the detection process. That is, the program is a program causing the information processing apparatus to perform the process flow illustrated in FIG. 12 or 34.

The information processing apparatus 1 according to the embodiments can be easily embodied using such a program. Then, the program may be stored in advance in a recording medium which is incorporated into a device such as a computer, a ROM in a microcomputer including a CPU, or the like. Alternatively, further, the program may be temporarily or permanently stored in a removable recording medium such as a semiconductor memory, a memory card, an optical disk, a magneto-optical disk, or a magnetic disk. Further, such a removable recording medium can be provided as a so-called software package. Further, in addition to installing such a program in a personal computer or the like from a removable recording medium, the program may be downloaded from a download site via a network such as a LAN or the Internet. The information processing apparatus and the information processing method according to an embodiment of the present technology can be embodied by a computer using such a program and can be widely provided.

Incidentally, in the embodiments, a mapping image indicating vegetation is generated, but the present technology is not limited to mapping of vegetation images and can be widely applied. For example, the present technology can be widely applied to apparatuses that generate a mapping image by mapping and arranging a plurality of captured images such as geometric images, map images, and city images.

Further, the present technology can be applied to mapping of vegetation index images and can also be applied to mapping of various images including visible light images (RGB images).

Incidentally, the advantageous effects described in this specification are merely exemplary but are not restricted arid other advantageous effects may be achieved.

Note the present technology can employ the following configurations.

(1)

An information processing apparatus comprising:

an area information generating circuitry configured to generate area information indicating each area of each image of a plurality of images, the plurality of images being projected onto a projection surface;

a detection circuitry configured to detect one or more areas that are designated by a user operation out of a plurality of areas, the plurality of areas based on the area information that is generated; and

an area selecting circuitry configured to select a portion of the plurality of areas based on the one or more areas that are detected.

(2)

The information processing apparatus according to (1), wherein images of the plurality of images are captured at different times and arranged in a time series

(3)

The information processing apparatus according to (1) or (2), further comprising an image generating circuitry configured to generate a map image by mapping images that correspond to the portion of the plurality of areas that are selected.

(4)

The information processing apparatus according to (3), wherein, to generate the map image by mapping the images that correspond to the portion of the plurality of areas that are selected, the image generating circuitry is further configured to combine the images that correspond to the portion of the plurality of areas that are selected into a single map image.

(5)

The information processing apparatus according to any of (1) to (4), wherein the detection circuitry is further configured to detect a second one or more areas that are individually designated by a second user operation out of the plurality of areas.

(6)

The information processing apparatus according to (5), further comprising an image generating circuitry,

wherein the area selecting circuitry is further configured to select a second portion of the plurality of areas based on the second one or more areas that are detected, and

wherein the image generating circuitry is configured to generate a map image by mapping images that correspond to the second portion of the plurality of areas that are selected.

(7)

The information processing apparatus according to (5), further comprising an image generating circuitry,

wherein the area selecting circuitry is further configured to select a second portion of the plurality of areas based on the second one or more areas that are detected, and

wherein the image generating circuitry is configured to generate a map image by mapping images that do not correspond to the second portion of the plurality of areas that are selected.

(8)

The information processing apparatus according to any one of (1) to (7), wherein the user operation includes a designation that the one or more areas are continuous areas.

(9)

The information processing apparatus according to (8), wherein the user operation includes a designation start area and a designation end area.

(10)

The information processing apparatus according to (8), wherein the user operation includes a designation end area.

(11)

The information processing apparatus according to (8), wherein the user operation includes a designation start area.

(12)

The information processing apparatus according to any one of (1) to (11), wherein the area selecting circuitry is further configured to select the portion of the plurality of areas based on the one or more areas that are detected and correspond to one or more conditions associated with an imaging device that captured the plurality of images.

(13)

The information processing apparatus according to (12), wherein the one or more conditions include a height of the imaging device at the time of capturing each image of the plurality of images.

(14)

The information processing apparatus according to (12), wherein the one or more conditions include a change in height of the imaging device at the time of capturing each image of the plurality of images.

(15)

The information processing apparatus according to (12), wherein the one or more conditions include an imaging orientation of the imaging device at the time of capturing each image of the plurality of images.

(16)

The information processing apparatus according to (12), wherein the imaging device is included in a drone.

(17)

The information processing apparatus according to any one of (1) to (16), wherein the area selecting circuitry is further configured to select, the portion of the plurality of areas based on a second user operation.

(18)

The information processing apparatus according to any one of (1) to (17), wherein the area information includes information of an outline of the each area of the each image of the plurality of images that are projected onto the projection surface.

(19)

An information processing method comprising:

generating, with an area information generating circuitry, area information indicating each area of each image of a plurality of images, the plurality of images being projected onto a projection surface;

detecting, with a detection circuitry, one or more areas that are designated by a user operation out of a plurality of areas, the plurality of areas based on the area information that is generated; and

selecting, with an area selecting circuitry, a portion of the plurality of areas based on the one or more areas that are detected.

(20)

A non-transitory computer-readable medium comprising instructions that, when executed by an electronic processor, cause the electronic processor to perform a set of operations comprising:

generating area information indicating each area of each image or a plurality of images, the plurality of images being projected onto a projection surface;

detecting one or more areas that are designated by a user operation out of a plurality of areas, the plurality of areas based on the area information that is generated; and

selecting a portion of the plurality of areas based on the one or more areas that are detected.

(21)

An information processing apparatus comprising:

a display; and

a display control circuitry configured to
generate area visualization information that visually indicates each area of each image of a plurality of images, the plurality of images being projected onto a projection surface,
control the display to display the area visualization information overlaid on the plurality of images projected on the projection surface,
receive an indication of one or more areas being designated by a user operation with respect to the area visualization information overlaid on the plurality of images projected on the projection surface, and
control the display to differentiate a display of the one or more areas from the display of the area visualization information overlaid on the plurality of images projected on the projection surface.

(22)

The information processing apparatus according to (21), wherein the display control circuitry is further configured to

generate a map image based on one or more images of the plurality of images that correspond to the one or more areas, and

control the display to display the map image.

(23)

An information processing apparatus including:

an area information generating unit that generates area information indicating each area of a plurality of images which are projected to a projection surface;

a detection unit that detects an area which is designated by a user operation out of a plurality of areas presented on the basis of the area information; and

an area selecting unit that selects at least some areas of the plurality of areas on the basis of the area detected by the detection unit.

(24)

The information processing apparatus according to (23), in which the plurality of images are a plurality of images which are captured at different times and arranged in a time series.

(25)

The information processing apparatus according to (23) or (24), further including an image generating unit that generates a mapping image by performing a mapping process using images corresponding t.o the areas selected by the area selecting unit out of the plurality of images.

(26)

The information processing apparatus according to (25), in which the mapping process is a process of associating and combining a plurality of images which are captured at different times and arranged in a time series to generate the mapping image.

(27)

The information processing apparatus according to any one of (23) to (26), in which the area selecting unit performs a process of selecting areas for a mapping process on the basis of the areas which are detected by the detection unit and which are individually designated by the user operation.

(28)

The information processing apparatus according to (27), in which the area selecting unit performs a process of selecting the areas which are detected by the detection unit and which are individually designated by the user operation as the areas which are used for the mapping process.

(29)

The information processing apparatus according to (27) or (28), in which the area selecting unit performs a process of selecting the areas which are detected by the detection unit and which are individually designated by the user operation as areas which are excluded from use for the mapping process.

(30)

The information processing apparatus according to any one of (23) to (26), in which the area selecting unit performs a process of selecting areas for a mapping process on the basis of the areas which are detected by the detection unit and which are designated as continuous areas by the user operation.

(31)

The information processing apparatus according to (30), in which the area selecting unit performs a process of selecting areas for the mapping process on the basis of a designation start, area and a designation end area which are detected by the detection unit and which are designated by the user operation.

(32)

The information processing apparatus according to (30) or (31), in which the area selecting unit performs a process of selecting areas for the mapping process on the basis of a designation end area which is detected by the detection unit and which is designated by the user operation.

(33)

The information processing apparatus according to any one of (30) to (32), in which the area selecting unit performs a process of selecting areas for the mapping process on the basis of a designation start area which is detected by the detection unit and which is designated by the user operation.

(34)

The information processing apparatus according to any one of (23) to (26) , in which the area selecting unit performs a process of selecting areas for the mapping process on the basis of areas which are detected by the detection unit and which correspond to a user's condition designating operation.

(35)

The information processing apparatus according to (34), in which designation of an area based on a condition of a height at which an imaging device is located at the time of capturing an image is able to be performed as the condition designating operation.

(36)

The information processing apparatus according to (34) or (35), in which designation of an area based on a condition of change in height of a position of an imaging device at the time of capturing an image is able to be performed as the condition designating operation.

(37)

The information processing apparatus according to (34) or (35), in which designation of an area based on a condition of an imaging orientation of an imaging device at the time of capturing an image is able to be performed as the condition designating operation.

(38)

The information processing apparatus according to any one of (23) to (37), in which the area information includes information of an outline of an area of an image which is projected to the projection surface.

(39)

An information processing method that an information processing apparatus performs:

a generation step of generating area information indicating each area of a plurality of images which are projected to a projection surface;

a detection step of detecting an area which is designated by a user operation out of a plurality of areas presented on the basis of the area information; and

an area selecting step of selecting at least some areas of the plurality of areas on the basis of the area detected in the detection step.

(40)

A program causing an information processing apparatus to perform:

a generation process of generating area information indicating each area of a plurality of images which are projected to a projection surface;

a detection process of detecting an area which is designated by a user operation out of a plurality of areas presented on the basis of the area information; and

an area selecting process of selecting at least some areas of the plurality of areas on the basis of the area detected in the detection process.

(41)

An information processing apparatus including a display control unit which is configured to perform:

a process of displaying area visualization information for visually displaying each area of a plurality of images which are projected to a projection surface; and

a process of displaying at least some areas of a plurality of areas on the basis of designation of an area by a user operation on display using the area visualization information.

(42)

The information processing apparatus according to (41), in which a process of displaying a mapping image which is generated using an image corresponding to an area selected on the basis of designation of the area by the user operation is performed.

It should be understood by those skilled in the art that various modifications, combinations, sub-combinations and alterations may occur depending on design requirements and other factors insofar a3 they are within the scope of the appended claims or the equivalents thereof.

### REFERENCE SIGNS LIST

1 Information processing apparatus

10 Storage and reproduction control unit

11 Area information generating unit

12 Area selecting unit

13 Detection unit

14 Image generating unit

15 Image generating unit

16 Display control unit

31 Imaging unit

32 Imaging signal processing unit

33 Camera control unit

34 Storage unit

35 Communication unit

41 Position detecting unit

42 Timepiece unit

43 Orientation detecting unit

44 Height detecting unit

51 CPU

52 ROM

53 RAM

54 Bus

55 Input and output interface

56 Display unit

57 Input unit

58 Sound output unit

59 Storage unit

60 Communication unit

61 Media drive

62 Memory card

80 Area selection interface image

81 Area selection image

82 Imaging point display button

83 Projection surface display button

84 Excluded area display button

85 Painting button

86 Start/end button

87 Condition setting unit

88 Condition selection execution button

89 Mapping button

90 Vegetation observation image

91 Mapping image

200 Flying object

210 Farm field

250 Imaging device

251 Sensor unit

W Frame

PT Imaging point

MP Map image

1. An information processing apparatus comprising:
an area information generating circuitry configured to generate area information indicating each area of each image of a plurality of images, the plurality of images being projected onto a projection surface;
a detection circuitry configured to detect one or more areas that are designated by a user operation out of a plurality of areas, the plurality of areas based on the area information that is generated; and
an area selecting circuitry configured to select a portion of the plurality of areas based on the one or more areas that are detected.

2. The information processing apparatus according to claim 1, wherein images of the plurality of images are captured at different times and arranged in a time series.

3. The information processing apparatus according to claim 1, further comprising an image generating circuitry configured to generate a map image by mapping images that correspond to the portion of the plurality of areas that are selected.

4. The information processing apparatus according to claim 3, wherein, to generate the map image by mapping the images that correspond to the portion of the plurality of areas that are selected, the image generating circuitry is further configured to combine the images that correspond to the portion of the plurality of areas that are selected into a single map image.

5. The information processing apparatus according to claim 1, wherein the detection circuitry is further configured to detect a second one or more areas that are individually designated by a second user operation out of the plurality of areas.

6. The information processing apparatus according to claim 5, further comprising an image generating circuitry,
wherein the area selecting circuitry is further configured to select a second portion of the plurality of areas based on the second one or more areas that are detected, and
wherein the image generating circuitry is configured to generate a map image by mapping images that correspond to the second portion of the plurality of areas that are selected.

7. The information processing apparatus according to claim 5, further comprising an image generating circuitry,
wherein the area selecting circuitry is further configured to select a second portion of the plurality of areas based on the second one or more areas that are detected, and
wherein the image generating circuitry is configured to generate a map image by mapping images that do not correspond to the second portion of the plurality of areas that are selected.

8. The information processing apparatus according to claim 1, wherein the user operation includes a designation that the one or more areas are continuous areas.

9. The information processing apparatus according to claim 8, wherein the user operation includes a designation start area and a designation end area.

10. The information processing apparatus according to claim 8, wherein the user operation includes a designation end area.

11. The information processing apparatus according to claim 8, wherein the user operation includes a designation start area.

12. The information processing apparatus according to claim 1, wherein the area selecting circuitry is further configured to select the portion of the plurality of areas based on the one or more areas that are detected and correspond to one or more conditions associated with an imaging device that captured the plurality of images.

13. The information processing apparatus according to claim 12, wherein the one or more conditions include a height of the imaging device at the time of capturing each image of the plurality of images.

14. The information processing apparatus according to claim 12, wherein the one or more conditions include a change in height of the imaging device at the time of capturing each image of the plurality of images.

15. The information processing apparatus according to claim 12, wherein the one or more conditions include an imaging orientation of the imaging device at the time of capturing each image of the plurality of images.

16. The information processing apparatus according to claim 12, wherein the imaging device is included in a drone.

17. The information processing apparatus according to claim 1, wherein the area selecting circuitry is further configured to select the portion of the plurality of areas based on a second user operation.

18. The information processing apparatus according to claim 1, wherein the area information includes information of an outline of the each area of the each image of the plurality of images that are projected onto the projection surface.

19. An information processing method comprising:
generating, with an area information generating circuitry, area information indicating each area of each image of a plurality of images, the plurality of images being projected onto a projection surface;
detecting, with a detection circuitry, one or more areas that are designated by a user operation out of a plurality of areas, the plurality of areas based on the area information that is generated; and
selecting, with an area selecting circuitry, a portion of the plurality of areas based on the one or more areas that are detected.

20. A non-transitory computer-readable medium comprising instructions that, when executed by an electronic processor, cause the electronic processor to perform a set of operations comprising:
generating area information indicating each area of each image of a plurality of images, the plurality of images being projected onto a projection surface;
detecting one or more areas that are designated by a user operation out of a plurality of areas, the plurality of areas based on the area information that is generated; and
selecting a portion of the plurality of areas based on the one or more areas that are detected.

21. An information processing apparatus comprising:
a display; and
a display control circuitry configured to
generate area visualization information that visually indicates each area of each image of a plurality of images, the plurality of images being projected onto a projection surface,
control the display to display the area visualization information overlaid on the plurality of images projected on the projection surface,
receive an indication of one or more areas being designated by a user operation with respect to the area visualization information overlaid on the plurality of images projected on the projection surface, and
control the display to differentiate a display of the one or more areas from the display of the area visualization information overlaid on the plurality of images projected on the projection surface.

22. The information processing apparatus according to claim 21, wherein the display control circuitry is further configured to
generate a map image based on one or more images of the plurality of images that correspond to the one or more areas, and
control the display to display the map image.
